(19) United States
(12) Patent Application Publication
(10) Pub. No.: US 2025/0227693 A1
(43) Pub. Date: Jul. 10, 2025

(54) RESOURCE ALLOCATION FOR UPLINK CONTROL INFORMATION WITH MULTIPLE SCHEDULED TRANSPORT BLOCKS

(71) Applicant: QUALCOMM Incorporated, San Diego, CA (US)

(72) Inventors: Shaozhen GUO, Beijing (CN); Mostafa KHOSHNEVISAN, San Diego, CA (US); Jing SUN, San Diego, CA (US); Xiaoxia ZHANG, San Diego, CA (US)

(21) Appl. No.: 18/850,438

(22) PCT Filed: Jun. 1, 2022
(86) PCT No.: PCT/CN2022/096571

§ 371 Date: Sep. 24, 2024

(51) Int. Cl. H04W 72/1268; H04L 1/00; H04W 72/21

(52) U.S. Cl. CPC H04W 72/1268; H04L 1/0003; H04W 72/21

(57) ABSTRACT

Methods, systems, and devices for wireless communications are described. A user equipment (UE) may receive a message that indicates to the UE to multiplex uplink control information (UCI) on an uplink shared channel (UL-SCH) that includes multiple scheduled transport blocks. The UE may calculate a first quantity of resources to transmit the UCI and a second quantity of resources available for UCI based on resources associated with one or more of the transport blocks. The UE may then use the minimum of the two quantities to determine a quantity of resources to use in multiplexing the UCI on the UL-SCH and transmit the UL-SCH transmission including the UCI.

### CROSS REFERENCE

The present Application is a 371 national phase filing of International PCT Application No. PCT/CN2022/096571 by GUO et al., entitled “RESOURCE ALLOCATION FOR UPLINK CONTROL INFORMATION WITH MULTIPLE SCHEDULED TRANSPORT BLOCKS,” filed Jun. 1, 2022, which is assigned to the assignee hereof, and which is expressly incorporated by reference in its entirety herein.

### FIELD OF TECHNOLOGY

The following relates to wireless communications, including resource allocation for uplink control information with multiple scheduled transport blocks.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques generally relate to improved methods, systems, devices, and apparatuses that support resource allocation for uplink control information (UCI) with multiple scheduled transport blocks. For example, a user equipment (UE) may receive a control message comprising scheduling for an uplink shared channel (UL-SCH) associated with a set of multiple transport blocks and an indication to multiplex UCI with the UL-SCH on one or more transport blocks of the set of multiple transport blocks based on the control message. The UE may calculate a first quantity of resources to transmit the UCI and a second quantity of resources available for UCI based on resources associated with one or more of the transport blocks. The UE may then use the minimum of the two quantities to determine a quantity of resources to use in multiplexing the UCI on the UL-SCH and transmit the UL-SCH transmission including the UCI. In some implementations, the UE may calculate the first quantity of resources based on a quantity and a size of code blocks associated with one or more of the transport blocks, based on a maximum or a minimum effective modulation and coding scheme (MCS) value of the transport blocks, or both. In some examples, the UE may be scheduled to transmit other UCIs. In these examples, the UE may calculate the second quantity of resources based on a difference of the available resources for UCI and a quantity of resources allocated to the other UCIs.

A method for wireless communication is described. The method may include receiving a control message including scheduling for an UL-SCH associated with a set of multiple transport blocks, multiplexing UCI with the UL-SCH on one or more transport blocks of the set of multiple transport blocks based on the control message, calculating a first quantity of resources for the UCI and a second quantity of resources for the UCI based on the set of multiple transport blocks, calculating a minimum value between the first quantity of resources and the second quantity of resources, and transmitting the UCI over the UL-SCH using a set of resources that corresponds to the minimum value.

An apparatus for wireless communication is described. The apparatus may include a processor, memory coupled with the processor, and instructions stored in the memory. The instructions may be executable by the processor to cause the apparatus to receive a control message including scheduling for an UL-SCH associated with a set of multiple transport blocks, multiplexing UCI with the UL-SCH on one or more transport blocks of the set of multiple transport blocks based on the control message, calculate a first quantity of resources for the UCI and a second quantity of resources for the UCI based on the set of multiple transport blocks, calculate a minimum value between the first quantity of resources and the second quantity of resources, and transmit the UCI over the UL-SCH using a set of resources that corresponds to the minimum value.

Another apparatus for wireless communication is described. The apparatus may include means for receiving a control message including scheduling for an UL-SCH associated with a set of multiple transport blocks, means for multiplexing UCI with the UL-SCH on one or more transport blocks of the set of multiple transport blocks based on the control message, means for calculating a first quantity of resources for the UCI and a second quantity of resources for the UCI based on the set of multiple transport blocks, means for calculating a minimum value between the first quantity of resources and the second quantity of resources, and means for transmitting the UCI over the UL-SCH using a set of resources that corresponds to the minimum value.

A non-transitory computer-readable medium storing code for wireless communication is described. The code may include instructions executable by a processor to receive a control message including scheduling for an UL-SCH associated with a set of multiple transport blocks, multiplexing UCI with the UL-SCH on one or more transport blocks of the set of multiple transport blocks based on the control message, calculate a first quantity of resources for the UCI and a second quantity of resources for the UCI based on the set of multiple transport blocks, calculate a minimum value between the first quantity of resources and the second quantity of resources, and transmit the UCI over the UL-SCH using a set of resources that corresponds to the minimum value.

In some examples of the method, apparatuses, and non-transitory computer-readable medium described herein, and the method, apparatuses, and non-transitory computer-readable medium may include further operations, features, means, or instructions for calculating a quantity of code blocks and a size of the code blocks, the code blocks associated with the transport block of the set of multiple transport blocks on which the UCI may be multiplexed, where calculating the first quantity of resources may be further based on a sum of the size of each code block of the quantity of the code blocks.

In some examples of the method, apparatuses, and non-transitory computer-readable medium described herein, and the method, apparatuses, and non-transitory computer-readable medium may include further operations, features, means, or instructions for calculating a quantity of code blocks and a size of the code blocks, the code blocks associated with the set of multiple transport blocks.

In some examples of the method, apparatuses, and non-transitory computer-readable medium described herein, calculating the first quantity of resources may include operations, features, means, or instructions for calculating a set of multiple sums, where the set of multiple sums includes a sum of the size of each code block of the quantity of the code blocks for each transport block of the set of multiple transport blocks and combining each of the sums of the set of multiple sums.

In some examples of the method, apparatuses, and non-transitory computer-readable medium described herein, and the method, apparatuses, and non-transitory computer-readable medium may include further operations, features, means, or instructions for calculating a combination of a quantity of layers of each transport block of the set of multiple transport blocks and calculating a product of the combination and a maximum effective MCS value, where calculating the first quantity of resources may be further based on the product.

Some examples of the method, apparatuses, and non-transitory computer-readable medium described herein may further include operations, features, means, or instructions for calculating a combination of a size of each code block of a set of multiple code blocks associated with the transport block and calculating a separation of the combination by a quantity of layers of the transport block.

In some examples of the method, apparatuses, and non-transitory computer-readable medium described herein, and the method, apparatuses, and non-transitory computer-readable medium may include further operations, features, means, or instructions for calculating a combination of a quantity of layers of each transport block of the set of multiple transport blocks and calculating a product of the combination and a minimum effective MCS value, where calculating the first quantity of resources may be further based on the product.

Some examples of the method, apparatuses, and non-transitory computer-readable medium described herein may further include operations, features, means, or instructions for calculating the minimum effective MCS value between each transport block of the set of multiple transport blocks, where an effective MCS value for a transport block may be calculated by, calculating a combination of a size of each code block of a set of multiple code blocks associated with the transport block, and calculating a separation of the combination by a quantity of layers of the transport block.

Some examples of the method, apparatuses, and non-transitory computer-readable medium described herein may further include operations, features, means, or instructions for receiving a second control message indicating a beta offset associated with the UCI, the control message including downlink control information, a medium access control-control element, radio resource control, or any combination thereof, where calculating the first quantity of resources may be further based on the beta offset.

In some examples of the method, apparatuses, and non-transitory computer-readable medium described herein, and the method, apparatuses, and non-transitory computer-readable medium may include further operations, features, means, or instructions for calculating a difference of a third quantity of resources available for UCI and a fourth quantity of resources associated with the one or more second UCI, where calculating the second quantity of resources may be further based on the difference.

Some examples of the method, apparatuses, and non-transitory computer-readable medium described herein may further include operations, features, means, or instructions for determining a mapping indicating the one or more second UCI mapped to resources of the UL-SCH prior to the first UCI.

In some examples of the method, apparatuses, and non-transitory computer-readable medium described herein, and the method, apparatuses, and non-transitory computer-readable medium may include further operations, features, means, or instructions for calculating a difference of a third quantity of resources available for UCI and a fourth quantity of resources associated with the one or more second UCI, where calculating the second quantity of resources may be further based on the difference.

Some examples of the method, apparatuses, and non-transitory computer-readable medium described herein may further include operations, features, means, or instructions for determining a mapping indicating the one or more second UCI mapped to resources of the UL-SCH prior to the first UCI.

In some examples of the method, apparatuses, and non-transitory computer-readable medium described herein, the first quantity of resources may be a quantity of resources required to transmit the UCI and the second quantity of resources may be a quantity of resources available to transmit the UCI.

In some examples of the method, apparatuses, and non-transitory computer-readable medium described herein, the control message includes downlink control information, radio resource control, or any combination thereof.

A method for wireless communication is described. The method may include outputting a control message including scheduling for an UL-SCH associated with a set of multiple transport blocks, multiplexing UCI on one or more transport blocks of the set of multiple transport blocks based on the control message, calculating a first quantity of resources for the UCI and a second quantity of resources for the UCI based on the set of multiple transport blocks, calculating a minimum value between the first quantity of resources and the second quantity of resources, and obtaining the UCI over the UL-SCH using a set of resources that corresponds to the minimum value.

An apparatus for wireless communication is described. The apparatus may include a processor, memory coupled with the processor, and instructions stored in the memory. The instructions may be executable by the processor to cause the apparatus to output a control message including scheduling for an UL-SCH associated with a set of multiple transport blocks, multiplexing UCI on one or more transport blocks of the set of multiple transport blocks based on the control message, calculate a first quantity of resources for the UCI and a second quantity of resources for the UCI based on the set of multiple transport blocks, calculate a minimum value between the first quantity of resources and the second quantity of resources, and obtain the UCI over the UL-SCH using a set of resources that corresponds to the minimum value.

Another apparatus for wireless communication is described. The apparatus may include means for outputting a control message including scheduling for an UL-SCH associated with a set of multiple transport blocks, means for multiplexing UCI on one or more transport blocks of the set of multiple transport blocks based on the control message, means for calculating a first quantity of resources for the UCI and a second quantity of resources for the UCI based on the set of multiple transport blocks, means for calculating a minimum value between the first quantity of resources and the second quantity of resources, and means for obtaining the UCI over the UL-SCH using a set of resources that corresponds to the minimum value.

A non-transitory computer-readable medium storing code for wireless communication is described. The code may include instructions executable by a processor to output a control message including scheduling for an UL-SCH associated with a set of multiple transport blocks, multiplexing UCI on one or more transport blocks of the set of multiple transport blocks based on the control message, calculate a first quantity of resources for the UCI and a second quantity of resources for the UCI based on the set of multiple transport blocks, calculate a minimum value between the first quantity of resources and the second quantity of resources, and obtain the UCI over the UL-SCH using a set of resources that corresponds to the minimum value.

In some examples of the method, apparatuses, and non-transitory computer-readable medium described herein, and the method, apparatuses, and non-transitory computer-readable medium may include further operations, features, means, or instructions for calculating a quantity of code blocks and a size of the code blocks, the code blocks associated with the transport block of the set of multiple transport blocks on which the UCI may be multiplexed, where calculating the first quantity of resources may be further based on a sum of the size of each code block of the quantity of the code blocks.

In some examples of the method, apparatuses, and non-transitory computer-readable medium described herein, and the method, apparatuses, and non-transitory computer-readable medium may include further operations, features, means, or instructions for calculating a quantity of code blocks and a size of the code blocks, the code blocks associated with the set of multiple transport blocks.

In some examples of the method, apparatuses, and non-transitory computer-readable medium described herein, calculating the first quantity of resources may include operations, features, means, or instructions for calculating a sum of the size of each code block of the quantity of the code blocks for each transport block of the set of multiple transport blocks and combining each of the sums.

In some examples of the method, apparatuses, and non-transitory computer-readable medium described herein, and the method, apparatuses, and non-transitory computer-readable medium may include further operations, features, means, or instructions for calculating a combination of a quantity of layers of each transport block of the set of multiple transport blocks and calculating a product of the combination and a maximum effective MCS value, where calculating the first quantity of resources may be further based on the product.

Some examples of the method, apparatuses, and non-transitory computer-readable medium described herein may further include operations, features, means, or instructions for calculating the maximum effective MCS value between each transport block of the set of multiple transport blocks, where an effective MCS value for a transport block may be calculated by, calculating a combination of a size of each code block of a set of multiple code blocks associated with the transport block, and calculating a separation of the combination by a quantity of layers of the transport block.

In some examples of the method, apparatuses, and non-transitory computer-readable medium described herein, and the method, apparatuses, and non-transitory computer-readable medium may include further operations, features, means, or instructions for calculating a combination of a quantity of layers of each transport block of the set of multiple transport blocks and calculating a product of the combination and a minimum effective MCS value, where calculating the first quantity of resources may be further based on the product.

Some examples of the method, apparatuses, and non-transitory computer-readable medium described herein may further include operations, features, means, or instructions for calculating the minimum effective MCS value between each transport block of the set of multiple transport blocks, where an effective MCS value for a transport block may be calculated by, calculating a combination of a size of each code block of a set of multiple code blocks associated with the transport block, and calculating a separation of the combination by a quantity of layers of the transport block.

Some examples of the method, apparatuses, and non-transitory computer-readable medium described herein may further include operations, features, means, or instructions for outputting a second control message indicating a beta offset associated with the UCI, the control message including downlink control information, a medium access control-control element, radio resource control, or any combination thereof, where calculating the first quantity of resources may be further based on the beta offset.

In some examples of the method, apparatuses, and non-transitory computer-readable medium described herein, and the method, apparatuses, and non-transitory computer-readable medium may include further operations, features, means, or instructions for calculating a difference of a third quantity of resources available for UCI and a fourth quantity of resources associated with the one or more second UCI, where calculating the second quantity of resources may be further based on the difference.

In some examples of the method, apparatuses, and non-transitory computer-readable medium described herein, and the method, apparatuses, and non-transitory computer-readable medium may include further operations, features, means, or instructions for calculating a difference of a third quantity of resources available for UCI and a fourth quantity of resources associated with the one or more second UCI, where calculating the second quantity of resources may be further based on the difference.

In some examples of the method, apparatuses, and non-transitory computer-readable medium described herein, the first quantity of resources may be a quantity of resources required to transmit the UCI and the second quantity of resources may be a quantity of resources available to transmit the UCI.

In some examples of the method, apparatuses, and non-transitory computer-readable medium described herein, the control message includes downlink control information, radio resource control, or any combination thereof.

### BRIEF DESCRIPTION OF THE DRAWINGS

FIGS. 1 and 2 illustrate examples of wireless communications systems that support resource allocation for uplink control information (UCI) with multiple scheduled transport blocks in accordance with one or more aspects of the present disclosure.

FIG. 3 illustrates an example of a configuration that supports resource allocation for UCI with multiple scheduled transport blocks in accordance with one or more aspects of the present disclosure.

FIGS. 4 and 5 show block diagrams of devices that support resource allocation for UCI with multiple scheduled transport blocks in accordance with one or more aspects of the present disclosure.

FIG. 6 shows a block diagram of a communications manager that supports resource allocation for UCI with multiple scheduled transport blocks in accordance with one or more aspects of the present disclosure.

FIG. 7 shows a diagram of a system including a device that supports resource allocation for UCI with multiple scheduled transport blocks in accordance with one or more aspects of the present disclosure.

FIGS. 8 and 9 show block diagrams of devices that support resource allocation for UCI with multiple scheduled transport blocks in accordance with one or more aspects of the present disclosure.

FIG. 10 shows a block diagram of a communications manager that supports resource allocation for UCI with multiple scheduled transport blocks in accordance with one or more aspects of the present disclosure.

FIG. 11 shows a diagram of a system including a device that supports resource allocation for UCI with multiple scheduled transport blocks in accordance with one or more aspects of the present disclosure.

FIGS. 12 through 15 show flowcharts illustrating methods that support resource allocation for UCI with multiple scheduled transport blocks in accordance with one or more aspects of the present disclosure.

### DETAILED DESCRIPTION

In some wireless communications systems, a user equipment (UE) may perform an uplink data transmission to a network entity via an uplink shared channel (UL-SCH). The network entity may schedule the UL-SCH transmission (e.g., via a dynamic grant (DG) or via control signaling referred to as a configured grant (CG)) with a transport block that includes multiple resources. In some cases, the UE may multiplex the scheduled UL-SCH (e.g., a physical uplink control channel (PUSCH)) transmission with uplink control information (UCI) on multiple resources of the transport block included in the UL-SCH. For example, a network entity may output a message that includes a mapping of UCI symbols to resources of a single transport block or the UE may calculate the mapping based on the single transport block. However, some wireless communications systems may support network entities scheduling multiple transport blocks with multiple layers of resources to increase uplink throughput and reliability. As such, a procedure that assumes a single transport block may result in ambiguity or uncertainty between the UE and the network entity as to whether the UE may multiplex the UCI with a given UL-SCH transmission that includes multiple transport blocks or how much of the UL-SCH transmission the UE may use for multiplexing UCI.

The present disclosure provide techniques for UCI resource allocation procedures with multiple scheduled transport blocks. For example, a UE may receive a control message comprising scheduling for a UL-SCH associated with a set of multiple transport blocks and an indication to multiplex UCI with the UL-SCH on one or more transport blocks of the set of multiple transport blocks based on the control message. The UE may calculate a first quantity of resources to transmit the UCI and a second quantity of resources available for UCI based on resources associated with one or more of the transport blocks. The UE may then use the minimum of the two quantities to determine a quantity of resources to use in multiplexing the UCI on the UL-SCH and transmit the UL-SCH transmission including the UCI. In some implementations, the UE may calculate the first quantity of resources based on a quantity and a size of code blocks associated with one or more of the transport blocks, based on a maximum or a minimum effective modulation and coding scheme (MCS) value of the transport blocks, or both. In some examples, the UE may be scheduled to transmit other UCIs. In these examples, the UE may calculate the second quantity of resources based on a difference of the available resources for UCI and a quantity of resources allocated to the other UCIs.

Aspects of the disclosure are initially described in the context of wireless communications systems. Aspects of the disclosure are further illustrated by and described with reference to apparatus diagrams, system diagrams, and flowcharts that relate to resource allocation for UCI with multiple scheduled transport blocks.

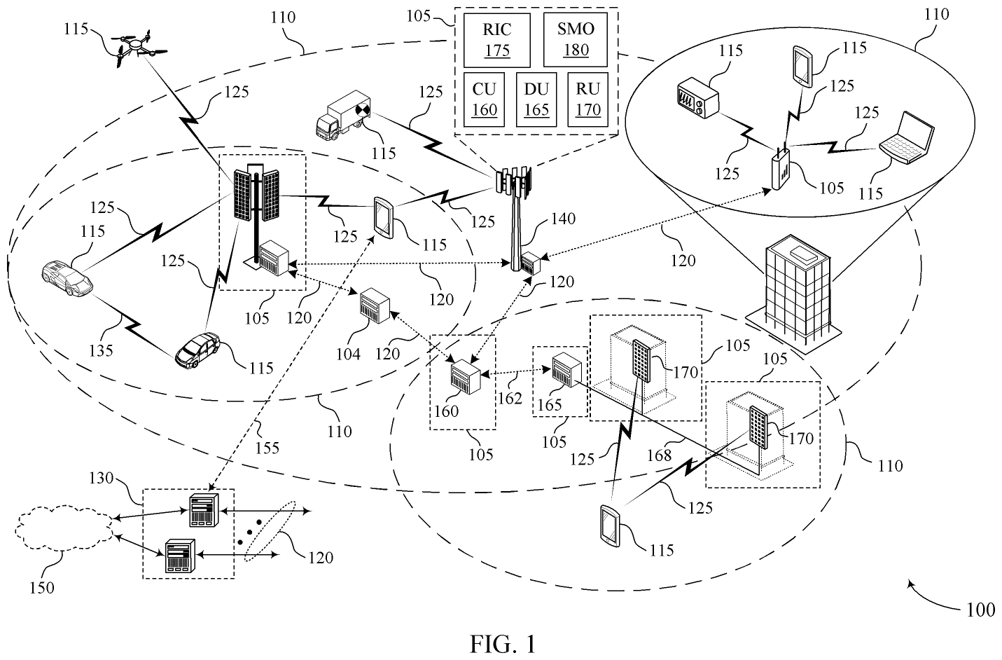

FIG. 1 illustrates an example of a wireless communications system 100 that supports resource allocation for UCI with multiple scheduled transport blocks in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support resource allocation for UCI with multiple scheduled transport blocks as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, in which case Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, a UE 115 may multiplex UCI on a PUSCH that includes an uplink data transmission. The UCI may include feedback (e.g., acknowledgment (ACK) or negative acknowledgment (NACK)) and channel state information (CSI), among other information. In some examples, the UCI may be mapped to resources (e.g., coded modulation symbols) of a single transport block around demodulation reference signal (DMRS) symbols. For example, a first set of DMRS symbols may be mapped to a first set of resources at a first time and a second set of DMRS symbols may be mapped to a second set of resources at a second time after the first time. The UCI may be mapped to resources at a time between the first time and the second time (e.g., a time after the first time and before the second time). As such, modulated HARQ-ACK symbols are mapped starting on the first available non-DMRS symbol after the first DMRS symbols, regardless of a quantity of DMRS symbols in the PUSCH transmission.

In some cases, the CSI may include a first part (e.g., CSI part one) and a second part (e.g., CSI part two). The CSI part one and the CSI part two may be mapped starting on the first available non-DMRS symbol, regardless of a quantity of DMRS symbols in the PUSCH transmission, based on if the PUSCH is punctured by the HARQ-ACK (e.g., a quantity of HARQ-ACK information bits is less than or equal to two) or rate matched by the HARQ-ACK (e.g., a quantity of HARQ-ACK information bits is greater than two).

In the case of punctured HARQ-ACK, the CSI part one is mapped starting after an amount of reserved HARQ-ACK resources (e.g., CSI part one is not mapped on the reserved HARQ-ACK resources) whereas CSI part two and PUSCH may be mapped to the resources reserved for HARQ-ACK (e.g., but not mapped on the CSI part one resources). In the case of rate matched HARQ-ACK, the HARQ-ACK may be mapped first, followed by CSI part one and CSI part two. In this case, the CSI part one and the CSI part two are mapped to resources other than the HARQ-ACK resources.

In some examples, if CG-UCI is present, then the CG-UCI is treated the same as HARQ-ACK. For example, if both HARQ-ACK and CG-UCI are present, then CG-UCI and HARQ-ACK are jointly encoded and then mapped to the resources following the rate matching procedure applied to HARQ-ACK previously described. If CG-UCI is present without HARQ-ACK, then CG-UCI is first encoded and then mapped to the resources following the rate matching procedure applied to HARQ-ACK previously described.

In some cases, the quantity of resources (e.g., coded modulation symbols) for UCI on PUSCH with UL-SCH per layer (e.g., per layer of a single transport block) for HARQ-ACK may be generated according to Equation 1:

$${Q}_{ACK}^{′} = min \{ \begin{matrix}⌈ \frac{( {O}_{ACK} + {L}_{ACK} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{l = {l}_{0}}^{{N}_{symb , all}^{PUSCH} - 1} {M}_{sc}^{UCI} ( l ) ⌉\end{matrix} \} \qquad Equation 1$$

where O_{ACK} is the quantity of HARQ-ACK bits, L_{ACK} is the quantity of CRC bits for HARQ-ACK β_{offset}^{PUSCH}=β_{offset}^{HARQ-ACK} (e.g., indicated by downlink control information (DCI) or configured by RRC), α is configured by higher layer parameter scaling, and l₀ is the symbol index of the first OFDM symbol that does not carry DMRS of the PUSCH, after the first DMRS symbol(s), in the PUSCH transmission. C_{UL-SCH} and Kᵣ are obtained from PDCCH scheduling the PUSCH transmission wherein C_{UL-SCH} is the quantity of code blocks for UL-SCH of the PUSCH transmission and Kᵣ is the r-th code block size for UL-SCH of the PUSCH transmission. M_{sc}^{UCI}(l) is the quantity of resource elements that can be used for transmission of UCI in OFDM symbol 1. N_{symb,all}^{PUSCH} is the quantity of OFDM symbols in PUSCH transmission duration, including all OFDM symbols used for DMRS, where for any OFDM symbol that carries DMRS M_{sc}^{UCI}(l)=0 and for any OFDM symbol that does not carry DMRS of the PUSCH M_{sc}^{UCI}(l)=M_{sc}^{PUSCH}−M_{sc}^{PT-RS}(l). M_{sc}^{PUSCH} is the scheduled bandwidth for PUSCH transmission in the current PUSCH transmission period for the transport block expressed in a quantity of subcarriers and M^{PT-RS}(l) is the quantity of subcarriers in OFDM symbol 1 that carries a phase tracking reference signal (PTRS), in the PUSCH transmission. In some examples

$$\frac{{\sum }_{l = {l}_{0}}^{{N}_{symb , all}^{PUSCH} - 1} {M}_{sc}^{UCI} ( l )}{{\sum }_{r = 0}^{{C}_{UL - SCH} - 1} {K}_{r}}$$

may refer to a quantity of resources that are required for each bit of information, and

$$α \cdot {\sum }_{l = {l}_{0}}^{{N}_{symb , all}^{PUSCH} - 1} {M}_{sc}^{UCI} ( l )$$

may refer to a quantity of resources that may be allocated to the HARQ-ACK information.

In some cases, the quantity of resources for UCI on PUSCH with UL-SCH per layer for CSI part one may be generated according to Equation 2:

$${Q}_{CSI - 1}^{′} = min \{ \begin{matrix}⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{l = {l}_{0}}^{{N}_{symb , all}^{PUSCH} - 1} {M}_{sc}^{UCI} ( l ) ⌉ - {Q}_{ACK / CG - UCI}^{′}\end{matrix} \} \qquad Equation 2$$

where O_{CSI-1} is a quantity of bits for CSI part one, L_{CSI-1} is a quantity of CRC bits, and β_{offset}^{PUSCH}=β_{offset}^{CSI-part 1} (e.g., indicated by DCI or configured by RRC). In some cases, Q_{ACK/CG-UCI}′=Q_{ACK}′ if HARQ-ACK is present for transmission on the same PUSCH with UL-SCH and without CG-UCI, where Q_{ACK}′ is the quantity of coded modulation symbols per layer for HARQ-ACK transmitted on the PUSCH if the quantity of HARQ-ACK information bits is greater than two and Q_{ACK}′ is the quantity of reserved resources if the quantity of HARQ-ACK information bits is less than or equal to two, Q_{ACK/CG-UCI}′=Q_{ACK}′ if both HARQ-ACK and CG-UCI are present on the same PUSCH with UL-SCH, where Q_{ACK}′ is the quantity of coded modulation symbols per layer for HARQ-ACK and CG-UCI transmitted on the PUSCH, or Q_{ACK/CG-UCI}′=Q_{CG-UCI}′ if CG-UCI is present on the same PUSCH with UL-SCH and without HARQ-ACK, where Q_{CG-UCI}′ is the number of coded modulation symbols per layer for CG-UCI transmitted on the PUSCH. In some examples,

$$⌈ α \cdot {\sum }_{l = 0}^{{N}_{symb , all}^{PUSCH} - 1} {M}_{c}^{UCI} ( l ) ⌉ - {Q}_{ACK / CG - UCI}^{′}$$

may refer to a quantity of resources that may be allocated to the CSI part one.

In some cases, the quantity of resources for UCI on PUSCH with UL-SCH per layer for CSI part two may be generated according to Equation 3:

$${Q}_{CSI - 2}^{′} = min \{ \begin{matrix}⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{l = {l}_{0}}^{{N}_{symb , all}^{PUSCH} - 1} {M}_{sc}^{UCI} ( l ) ⌉ - {Q}_{ACK / CG - UCI}^{′} - {Q}_{CSI - 1}^{′}\end{matrix} \} \qquad Equation 3$$

where O_{CSI-2} is a quantity of bits for CSI part two, L_{CSI-2} is a quantity of CRC bits, and β_{offset}^{PUSCH}=β_{offset}^{CSI-part 2} (e.g., indicated by DCI or configured by RRC). In some cases, Q_{ACK/CG-UCI}=Q_{ACK}′, if HARQ-ACK is present for transmission on the same PUSCH with UL-SCH and without CG-UCI, where Q_{ACK}′ is the quantity of coded modulation symbols per layer for HARQ-ACK transmitted on the PUSCH if the number of HARQ-ACK information bits is greater than two and Q_{ACK}′=0 if the number of HARQ-ACK information bits is less than or equal to two, Q_{ACK/CG-UCI}′=Q_{ACK}′ if both HARQ-ACK and CG-UCI are present on the same PUSCH with UL-SCH, where Q_{ACK}′ is the number of coded modulation symbols per layer for HARQ-ACK and CG-UCI transmitted on the PUSCH, Q_{ACK/CG-UCI}′=Q_{CG-UCI}′ if CG-UCI is present on the same PUSCH with UL-SCH and without HARQ-ACK, where Q_{CG-UCI}′ is the quantity of coded modulation symbols per layer for CG-UCI transmitted on the PUSCH, and Q_{CSI-1}′ is the number of coded modulation symbols per layer for CSI part one transmitted on the PUSCH. In some examples,

$$⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} - {Q}_{CSI - 1}^{′}$$

may refer to a quantity of resources that may be allocated to the CSI part two.

In some cases, the quantity of resources for UCI on PUSCH with UL-SCH per layer for CG-UCI may be generated according to Equation 4:

$${Q}_{CG - UCI}^{′} = min \{ \begin{matrix}⌈ \frac{( {O}_{CG - UCI} + {L}_{CG - UCI} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{l = {l}_{0}}^{{N}_{symb , all}^{PUSCH} - 1} {M}_{sc}^{UCI} ( l ) ⌉\end{matrix} \} \qquad Equation 4$$

where O_{CG-UCI} is a quantity of bits for CG-UCI, L_{CG-UCI} is quantity of CRC bits, and β_{offset}^{PUSCH}=β_{offset}^{CG-UCI}.

In some aspects, however, the UE 115 and the network entity 105 may support multiple (e.g., two) codewords and multiple (e.g., two) transport blocks for a PUSCH transmission (e.g., an uplink transmission with more than one layer). For example, the UE 115 and the network entity 105 may introduce or otherwise support multiple codewords and transport blocks (e.g., each transport block with different transmission parameters, such as MCS, new data indicator (NDI), redundancy version (RV), and the like) as part of a more than four layer (with eight transmission ports) transmission or as part of a simultaneous multi-panel transmission, or both. As such, the UE 115 and the network entity 105 may support one or more uplink DMRS, sounding reference signal (SRS), SRS resource indicator (SRI), or transmit precoding matrix indicator (TPMI) (including codebook) enhancements to enable eight transmission port uplink operation to support four and more layers per UE in uplink (e.g., for customer premises equipment (CPE), fixed wireless access (FWA), vehicle, or industrial devices). The UE 115 and the network entity 105 may support updates, rules, or constraints associated with coherence assumption or full/non-full power modes as part of such DMRS, SRS, SRI, or TPMI enhancements. Further, the UE 115 and the network entity 105 may facilitate simultaneous multi-panel uplink transmission for higher uplink throughput or reliability (e.g., for FR2 or multi-TRP operation, assuming up to two TRPs and up to two panels, and, for example, for CPE, FWA, vehicle, or industrial devices, if applicable) in accordance with an uplink precoding indication for PUSCH without introducing a new codebook for multi-panel simultaneous transmission. In such aspects, a total quantity of layers may be up to four across a set of (e.g., all) panels and a total quantity of codewords may be up to two across a set of (e.g., all) panels, considering single DCI or multi-DCI based multi-TRP operation. As such, when a network entity 105 schedules two or more transport blocks for a PUSCH and a UE 115 multiplexes UCI on the PUSCH, a procedure that assumes a single transport block may result in ambiguity or uncertainty between the UE 115 and the network entity 105 as to which transport block should be considered for calculating a quantity of coded modulation symbols for a given UCI.

To determine a quantity of coded modulation symbols per layer for each UCI when PUSCH with two transport blocks are scheduled, UCI resource allocation procedures may be updated. For example, a quantity of coded modulation symbols (e.g., resources) for a given UCI (denoted by Q_{UCI-type}′) may be calculated by calculating a quantity of resources that are required for the given UCI information (denoted by Q_{UCI-type}^{required}) based on resources associated with one or more of the transport blocks, calculate a quantity of resources that may be allocated to the given UCI information (denoted by Q_{UCI-type}^{available}) based on resources associated with one or more of the transport blocks, and taking the minimum value between the quantity of resources that are required for the given UCI information (e.g., Q_{UCI-type}^{required}) and the quantity of resources that may be allocated to the given UCI information (e.g., Q_{UCI-type}^{available}) to be used as the quantity of coded modulation symbols for the UCI.

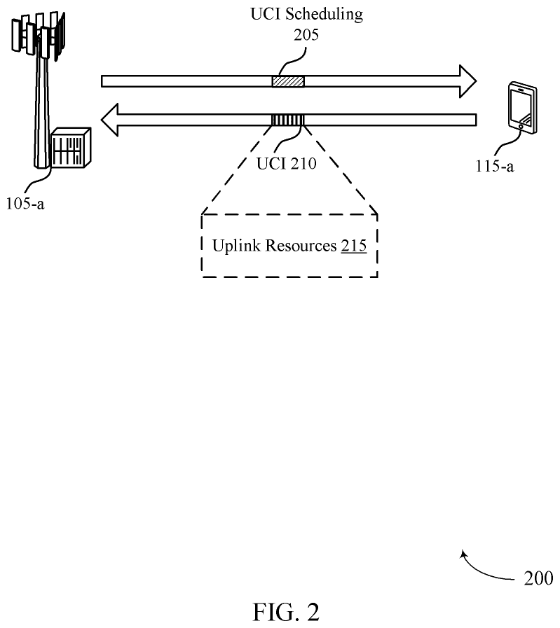

FIG. 2 illustrates an example of a wireless communications system 200 that supports resource allocation for UCI with multiple scheduled transport blocks in accordance with one or more aspects of the present disclosure. In some examples, the wireless communications system 200 may implement aspects of the wireless communications system 100. For example, the wireless communications system 200 may include a network entity 105-a and a UE 115-a, which may be examples of a network entity 105 and a UE 115 respectively, as described herein with reference to FIG. 1. The network entity 105-a and the UE 115-a may be in wireless communication.

In some cases, the network entity 105-a may output a control message (e.g., UCI scheduling 205) that includes scheduling for an UL-SCH transmission with a single transport block. Based on the available resources of the transport block, the UE 115-a may determine which resources to use for multiplexing UCI. However, some wireless communications systems 200 may support the network entity 105-a scheduling multiple transport blocks (e.g., PUSCH scheduled with two transport blocks). Because the UE 115-a may assume, in some implementations, to be scheduled with a single transport block, determinations of how to multiplex the UCI on the resources of the transport block may be ambiguous or uncertain (e.g., the UE 115-a may not have means for determining which transport block to use). Thus, updated techniques for UCI resource allocation procedures that may define how to multiplex UCI with multiple scheduled transport blocks may be beneficial (e.g., increase throughput, reliability, explicit and more efficient utilization of communication resources, etc.).

In order to determine how to multiplex the UCI with multiple scheduled transport blocks, aspects of the present disclosure enable the UE 115-a to determine (calculate) a quantity of resources per layer (e.g., per layer of one or more of the transport blocks) for each UCI (e.g., multiple portions of a UCI (such as HARQ-ACK, CG-UCI, CSI part one, and CSI part two) may include different calculations).

In some examples, the UE 115-a may receive a control message (e.g., a DCI, a MAC control element (MAC-CE), an RRC, or the like) that includes scheduling information for a UL-SCH (e.g., a PUSCH) associated with multiple transport blocks. The transport blocks may include two transport blocks and two codewords or more than two transport blocks and more than two codewords. In some cases, each transport block may include individual transmission parameters. For example, each transport block may include individual MCS, NDI, RV, and the like, making each transport block potentially different or unique from other transport blocks scheduled by the network entity 105-a.

In some implementations, the network entity 105-a may output a message indicating how to multiplex UCI on one or more of the transport blocks. For example, the network entity 105-a may schedule the multiple transport blocks in a message, and in a same or separate message may also configure (e.g., indicate rules, equations, or constraints) the UE 115-a on how to perform a resource allocation procedure for each portion of the UCI. Additionally, or alternatively, the UE 115-a may be configured (e.g., with a fixed rule based on a specification) on how to perform the resource allocation procedure.

The UE 115-a may then perform the resource allocation procedure. For example, the UE 115-a may determine to multiplex UCI on one or more of the multiple scheduled transport blocks based on the control message. The UE 115-a may determine (calculate) a first quantity of resources (e.g., resources required to transmit the UCI) and a second quantity of resources (e.g., resources available to transmit the UCI) for the UCI based on the multiple scheduled transport blocks.

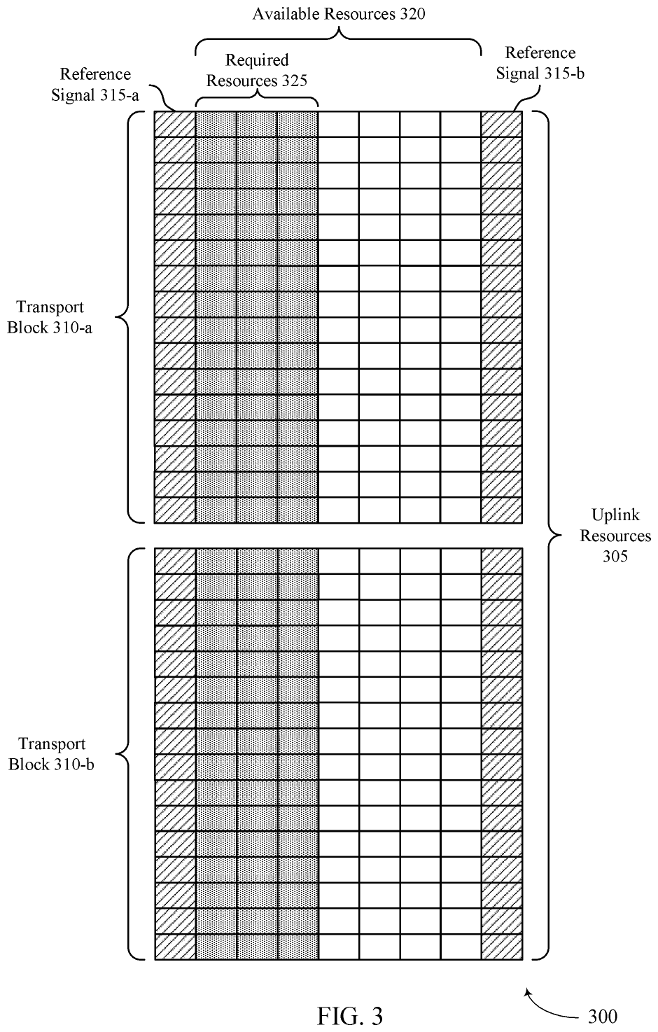

In some implementations, the determination for a given UCI (e.g., HARQ-ACK, CG-UCI, CSI part one, or CSI part two) to determine the first quantity of resources (e.g., Q_{UCI-type}^{required}) required may include multiplexing the UCI on a first transport block of the scheduled transport blocks. The calculation may then include a quantity of code blocks and a code block size for each code block corresponding to the first transport block that the given UCI is multiplexed. For example, the UE 115-a may be configured to multiplex the given UCI on all layers of the first transport block of an UL-SCH (e.g., a PUSCH) when the PUSCH is scheduled with two or more transport blocks, as described herein with reference to Equation 5 of FIG. 3.

In some implementations, the determination for a given UCI to determine the first quantity of resources (e.g., Q_{UCI-type}^{required}) may include multiplexing the UCI on two or more transport blocks of the scheduled transport blocks. The calculation may then include a quantity of code blocks and a code block size for each code block corresponding to the two or more transport blocks (e.g., a total quantity of bits across all layers of the two or more transport blocks) that the given UCI is multiplexed. For example, the UE 115-a may be configured to multiplex the given UCI on all layers of the two or more transport blocks (e.g., all scheduled transport blocks) of an UL-SCH (e.g., a PUSCH) when the PUSCH is scheduled with two or more transport blocks, as described herein with reference to Equation 6 of FIG. 3.

In some implementations, determining the first quantity of resources (e.g., Q_{UCI-type}^{required}) for a given UCI may include multiplexing the UCI on two or more transport blocks of the scheduled transport blocks. The calculation may then include calculating an effective MCS (e.g., a highest or max effective MCS among the two or more transport blocks or a lowest or min effective MCS among the two or more transport blocks), where the quantity of bits per layer corresponding to the transport block with the calculated effective MCS is used as the number of bits for each layer across the two or more transport blocks. For example, the UE 115-a may be configured to multiplex the given UCI on all layers of the two or more transport blocks (e.g., all scheduled transport blocks) of an UL-SCH (e.g., a PUSCH) when the PUSCH is scheduled with two or more transport blocks, as described herein with reference to Equation 7 of FIG. 3. In some examples, utilizing the effective MCS may get a higher or lower (e.g., more or less) quantity of resources that are required for the given UCI (e.g., based on utilizing the max or min effective MCS). In some cases, the effective MCS may be a product of the modulation order and coding rate.

In some cases, the network entity 105-a may output a second control message that indicates a beta offset associated with the UCI. For example, the network entity 105-a may output a DCI, a MAC-CE, or an RRC that includes the indication of the beta offset. The UE 115-a may further use the indicated beta offset in the calculation of the first quantity of resources.

In some examples, the determination for a given UCI to determine the second quantity of resources (e.g., Q_{given-UCI}^{available}) may include multiplexing a first UCI (e.g., a first portion of the UCI (e.g., CSI part one or CSI part two)) and one or more second UCI (e.g., a second portion of the UCI (e.g., HARQ-ACK, CG-UCI, and/or CSI part one)) on a same transport block. In some cases, the quantity of resources that may be allocated to the first UCI (e.g., CSI part one and CSI part 2) may be determined by calculating a quantity of resources that have been allocated to the one or more second UCI (e.g., determining a mapping indicating the one or more second UCI mapped to resources of the UL-SCH prior to the first UCI) and excluding them when the one or more second UCI are multiplexed on the same transport block that the given UCI (e.g., the first UCI) is multiplexed, as described herein with reference to Equation 8 of FIG. 3. For example, the UE 115-a may calculate a quantity of resources available for CSI part one. The UE 115-a may determine how many resources are available for HARQ-ACK and CG-UCI and exclude that quantity of resources from the calculation of resources available for the CSI part one. Similarly, the UE 115-a may calculate a quantity of resources available for CSI part two by excluding a quantity of resources available for HARQ-ACK, CG-UCI, and CSI part one from the calculation of resources available for the CSI part two. In some cases, excluding the one or more second UCI that are multiplexed on the same transport block as the first UCI may imply that the different UCI (e.g., the first and second UCI) may be mapped to the same resources when different UCI are mapped to layers of different transport blocks.

In some examples, the determination for a given UCI to determine the second quantity of resources (e.g., Q_{given-UCI}^{available}) may include multiplexing a first UCI (e.g., a first portion of the UCI (e.g., CSI part one or CSI part two)) on a first transport block and one or more second UCI (e.g., a second portion of the UCI (e.g., HARQ-ACK, CG-UCI, and/or CSI part one)) on one or more second transport blocks (e.g., one or more second transport blocks that may include the first transport block). For example, the quantity of resources that have been allocated to the one or more second UCI (e.g., determining a mapping indicating the one or more second UCI mapped to resources of the UL-SCH prior to the first UCI) are excluded regardless of whether the one or more second UCI are multiplexed on the same transport block that the first UCI is multiplexed, as described herein with reference to Equation 8 of FIG. 3. For example, the UE 115-a may calculate a quantity of resources available for CSI part one. The UE 115-a may determine how many resources are available for HARQ-ACK and CG-UCI and exclude that quantity of resources from the calculation of resources available for the CSI part one regardless of which transport block they are multiplexed on. Similarly, the UE 115-a may calculate a quantity of resources available for CSI part two by excluding a quantity of resources available for HARQ-ACK, CG-UCI, and CSI part one from the calculation of resources available for the CSI part two regardless of which transport block they are multiplexed on. In some cases, excluding the one or more second UCI regardless of which transport block they are multiplexed on may imply that the different UCI (e.g., the first and second UCI) may be mapped to different resources regardless of whether different UCI are mapped to layers of same transport blocks or different transport blocks.

After determining the first quantity of resources and the second quantity of resources, the UE 115-a may then determine a minimum value between the first quantity of resources and the second quantity of resources. For example, uplink resources 215 may include a minimum value between the quantity of resources that are required (e.g., Q_{UCI-type}^{required}) for a UCI 210 (e.g., the given UCI) and the quantity of resources that may be allocated (e.g., Q_{given-UCI}^{available}) to UCI 210. In some cases, the uplink resources 215 may be determined based on one or more of the various implementations and examples described herein. The UE 115-a may then transmit the UCI 210, using the uplink resources 215, on the UL-SCH (e.g., the PUSCH).

FIG. 3 illustrates an example of a configuration 300 that supports resource allocation for UCI with multiple scheduled transport blocks in accordance with one or more aspects of the present disclosure. In some examples, the configuration 300 may implement or be implemented by aspects of the wireless communications systems 100 and 200 as described with reference to FIGS. 1 and 2, respectively. For example, the configuration 300 may be implemented by a network entity 105 and a UE 115 as described with reference to FIGS. 1 and 2, respectively. In the following description of the configuration 300, the quantity of transport blocks 310, available resources 320, required resources 325, and uplink resources 305 may include differing quantities than depicted in FIG. 3. For example, some resources or transport blocks may be added and some resources may be omitted to each. In some cases, the transport blocks 310 may include multiple layers.

In some examples, a UE 115 may determine resource allocation for UCI with multiple scheduled transport blocks. For example, the UE 115 may receive a control message that includes scheduling information for a UL-SCH associated with uplink resources 305. The uplink resources 305 may include at least a transport block 310-a and a transport block 310-b. The transport block 310-a may include resources reserved for a first reference signal 315-a (e.g., a DMRS, a PTRS, or other reference signal) and a second reference signal 315-b.

In some cases, the UE 115 may multiplex UCI between the first reference signal 315-a and the second reference signal 315-b. The resources after the first reference signal 315-a may be resources available for UCI (e.g., available resources 320). In some cases, the resources prior to the first reference signal 315-a may also be resources available for UCI (e.g., for CSI part one and CSI part two). In some cases, a portion of the available resources 320 may include resources required for the transmission of the UCI (e.g., required resources 325). In some examples, a quantity of the required resources 325 may be greater than a quantity of the available resources 320 or vice versa. To calculate the two quantities and determine which resources to use for transmitting the UCI, the UE 115 may calculate a first quantity of resources (e.g., the required resources 325) and a second quantity of resources (e.g., the available resources 320) based on the multiple transport blocks 310 (e.g., the transport block 310-a and the transport block 310-b).

In some implementations, the UE 115 may calculate the required resources 325 by calculating a quantity of code blocks, a size of the code blocks, and a sum (e.g., addition) of the size of each code block associated with a transport block (e.g., the first transport block 310-a or the second transport block 310-b) of the multiple transport blocks, according to Equation 5:

$${Q}_{UCI - type}^{required} = ⌈ \frac{( {O}_{UCI - type} + \text{} {L}_{UCI - type} ) \cdot \text{} {β}_{offset}^{UCI - type} \cdot \text{} {\sum }_{l = 0}^{{N}_{symb , all}^{PUSCH} - 1} \text{} {M}_{sc}^{UCI} ( \text{} l \text{} )}{( {\sum }_{r = 0}^{{C}_{UL - SCH}^{( x )} - 1} {K}_{r}^{( x )} )} ⌉ \qquad Equation 5$$

where C_{UL-SCH}^{(x)} is the quantity of code blocks for UL-SCH of the PUSCH transmission corresponding to the transport block (e.g., the first transport block 310-a) that the given UCI (e.g., HARQ-ACK, CG-UCI, CSI part one, and/or CSI part two) is multiplexed and Kᵣ is the r-th code block size for UL-SCH of the PUSCH transmission corresponding to the transport block (e.g., the first transport block 310-a) that the given UCI is multiplexed. For example, if the given UCI is multiplexed on the first transport block 310-a, then x=1, and if the given UCI is multiplexed on the second transport block 310-b, then x=2. As described herein with reference to FIG. 2, β_{offset}^{UCI-type} for a given UCI can be indicated by DCI or configured by RRC.

In some implementations, the UE 115 may calculate the required resources 325 by calculating a quantity of code blocks, a size of the code blocks, and a sum (e.g., addition) of the size of each code block for each transport block (e.g., the transport block 310-a and the transport block 310-b) of the multiple transport blocks and combining each of the sums, according to Equation 6:

$${Q}_{UCI - type}^{required} = ⌈ \frac{( {O}_{UCI - type} + \text{} {L}_{UCI - type} ) \cdot \text{} {β}_{offset}^{UCI - type} \cdot \text{} {\sum }_{l = 0}^{{N}_{symb , all}^{PUSCH} - 1} \text{} {M}_{sc}^{UCI} ( \text{} l \text{} )}{( {\sum }_{r = 0}^{{C}_{UL - SCH}^{( 1 )} - 1} {K}_{r}^{( 1 )} + {\sum }_{r = 0}^{{C}_{UL - SCH}^{( 2 )} - 1} {K}_{r}^{( 2 )} )} ⌉ \qquad Equation 6$$

where C_{UL-SCH}⁽¹⁾ is the quantity of code blocks for UL-SCH of the PUSCH transmission corresponding to the first transport block 310-a and Kᵣ is the r-th code block size for UL-SCH of the PUSCH transmission corresponding to the first transport block 310-a, and C_{UL-SCH}⁽²⁾ is the quantity of code blocks for UL-SCH of the PUSCH transmission corresponding to the second transport block 310-b and Kᵣ is the r-th code block size for UL-SCH of the PUSCH transmission corresponding to the second transport block 310-b.

In some implementations, the UE 115 may calculate the required resources 325 by calculating an effective MCS (e.g., a highest or max effective MCS among the two or more transport blocks or a lowest or min effective MCS among the two or more transport blocks). For example, the UE 115 may calculate a combination of a quantity of layers of each transport block 310 (e.g., both the transport block 310-a and the transport block 310-b) and a product (e.g., multiplication) of the combination and the effective MCS (e.g., the max effective MCS or the min effective MCS). In some cases, calculating the effective MCS for the transport block 310-a may include calculating a combination (e.g., a sum) of a size of each code block associated with the transport block 310-a and calculating a separation (e.g., a division) of the combination by a quantity of layers of the transport block 310-a.

In some cases, the UE 115 may calculate the required resources 325 utilizing the effective MCS according to Equation 7:

$${Q}_{UCI - type}^{required} = ⌈ \frac{( {O}_{UCI - type} + \text{} {L}_{UCI - type} ) \cdot \text{} {β}_{offset}^{UCI - type} \cdot \text{} {\sum }_{l = 0}^{{N}_{symb , all}^{PUSCH} - 1} \text{} {M}_{sc}^{UCI} ( \text{} l \text{} )}{{\sum }_{r = 0}^{{C}_{UL - SCH}^{( x )} - 1} {K}_{r}^{( x )} \cdot ( {N}_{layer}^{1} + {N}_{layer}^{2} ) / {N}_{layer}^{( x )}} ⌉ \qquad Equation 7$$

where C_{UL-SCH}^{(x)} is the quantity of code blocks for UL-SCH of the PUSCH transmission corresponding to the transport block 310 with the highest effective MCS or the lowest effective MCS, Kᵣ is the r-th code block size for UL-SCH of the PUSCH transmission corresponding to the transport block 310 with the highest effective MCS or the lowest effective MCS, N_{layer}^{(x)} is the quantity of layers corresponding to the transport block 310 with the highest effective MCS or the lowest effective MCS, and N_{layer}¹ is the number of layers corresponding to the first transport block 310-a and N_{layer}² is the number of layers corresponding to the second transport block 310-b. In some cases, the UE 115 may determine to utilize the highest effective MCS or the lowest effective MCS based on the control message, a fixed rule, or some other form of UE configuration.

In some examples, the UE 115 may calculate the available resources 320 for a given UCI (e.g., a portion of the UCI (e.g., CSI part one or CSI part two) by calculating a difference between a quantity of resources available for UCI (e.g., all UCI) and a quantity of resources associated with other UCI (e.g., HARQ-ACK, CG-UCI, or CSI part one) according to Equation 8:

$${Q}_{given - UCI}^{available} = ⌈ α \cdot {\sum }_{l = 0}^{{N}_{symb , all}^{PUSCH} - 1} {M}_{sc}^{UCI} ( l ) ⌉ - {Q}_{OtherUCIs}^{( x )} \qquad Equation 8$$

where Q_{OtherUCIs}^{(x)} is the quantity of resources that have been allocated to the other UCI.

In some cases, the quantity of resources associated with other UCI (e.g., Q_{OtherUCIs}^{(x)}) may depend on if the given UCI and the other UCI are multiplexed on the same transport block 310. In a first scenario, Q_{OtherUCIs}^{(x)} is the quantity of resources that has been allocated to other UCIs if the given UCI is multiplexed on the transport block 310-a and the other UCI is also multiplexed on the transport block 310-a, then Q_{OtherUCIs}^{(x)}=0 if the other UCI is not multiplexed on the transport block 310-a. In a second scenario, Q_{OtherUCIs}^{(x)} is the quantity of resources that has been allocated to other UCIs regardless of which transport block 310 the given UCI and the other UCI are multiplexed on, Q_{OtherUCIs}^{(x)}=0 if the other UCI is not multiplexed on any transport block 310 (e.g., the PUSCH) that the given UCI is multiplexed on.

For example, when calculating a quantity of resources available for CSI part one, if HARQ-ACK/CG-UCI is multiplexed on the transport block 310-a and CSI part one is multiplexed on the transport block 310-b (e.g., HARQ-ACK/CG-UCI and CSI part one are multiplexed on different transport blocks 310), where each is multiplexed on a single transport block 310, then given the first scenario the quantity of resources that have been allocated to the other UCI (e.g., Q_{ACK/CG-UCI}′) may be zero. Alternatively, given the second scenario, the quantity of resources that have been allocated to the other UCI (e.g., Q_{ACK/CG-UCI}′) may be the quantity of resources that have been allocated to the HARQ-ACK/CG-UCI.

Regardless of the first or second scenario (e.g., given either the first or second scenario), if HARQ-ACK/CG-UCI and CSI part one are multiplexed on the same transport block 310-a (each is multiplexed on a single transport block 310), HARQ-ACK/CG-UCI is multiplexed on both the transport block 310-a and the transport block 310-b and CSI part one is multiplexed on the transport block 310-a (e.g., multiplexed on one of the two transport blocks 310), or HARQ-ACK/CG-UCI is multiplexed on the transport block 310-a (e.g., multiplexed on one of the two transport blocks 310) and CSI part one is multiplexed on the transport block 310-a and the transport block 310-b, then the quantity of resources that have been allocated to the other UCI (e.g., Q_{ACK/CG-UCI}′) may be the quantity of resources that have been allocated to the HARQ-ACK/CG-UCI.

In another example, when calculating a quantity of resources available for CSI part two, if CSI part one is multiplexed on the transport block 310-a and CSI part two is multiplexed on the transport block 310-b (e.g., CSI part one and CSI part two are multiplexed on different transport blocks 310), where each is multiplexed on a single transport block 310, then given the first scenario the quantity of resources that have been allocated to the other UCI (e.g., Q_{CSI-1}′) may be zero. Alternatively, given the second scenario, the quantity of resources that have been allocated to the other UCI (e.g., Q_{CSI-1}′) may be the quantity of resources that have been allocated to the CSI part 1.

Regardless of the first or second scenario (e.g., given either the first or second scenario), if CSI part one and CSI part two are multiplexed on the same transport block 310-a (each is multiplexed on a single transport block 310), CSI part one is multiplexed on both the transport block 310-a and the transport block 310-b and CSI part two is multiplexed on the transport block 310-a (e.g., multiplexed on one of the two transport blocks 310), or CSI part one is multiplexed on the transport block 310-a (e.g., multiplexed on one of the two transport blocks 310) and CSI part two is multiplexed on the transport block 310-a and the transport block 310-b, then the quantity of resources that have been allocated to the other UCI (e.g., Q_{CSI-1}′) may be the quantity of resources that have been allocated to the CSI part 1.

Additionally, or alternatively, when calculating a quantity of resources available for CSI part two, the quantity of resources that have been allocated to HARQ-ACK or CG-UCI (e.g., Q_{ACK/CG-UCI}′) may also be considered. For example, for CSI part two, Q_{CSI-1}′ may be determined based on a similar rule (e.g., configuration) as CSI part one by replacing CSI part one with CSI part two.

After determining the quantity of available resources 320 and the quantity of required resources 325, the UE 115 may use the minimum between the two resource quantities as a quantity of resources for the UCI. The UE 115 may then transmit the UCI on the UL-SCH (e.g., the PUSCH) to a network entity 105.

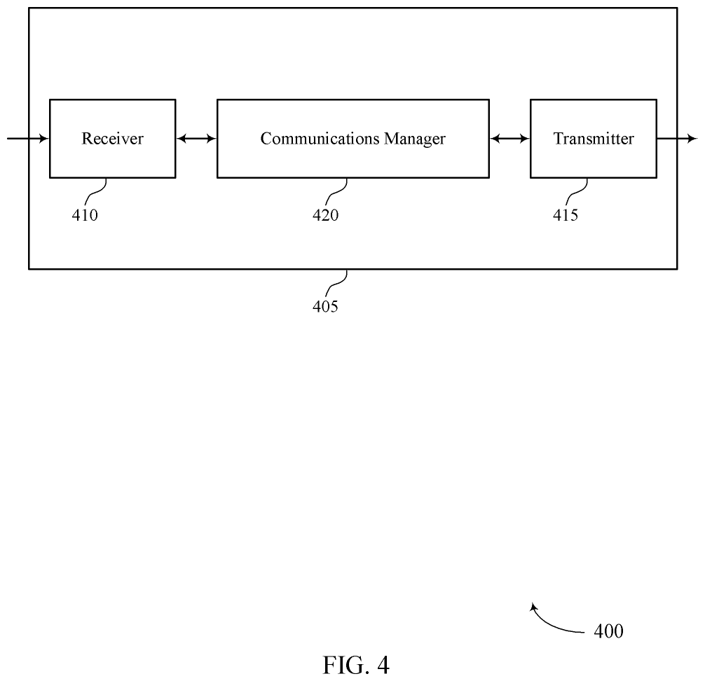

FIG. 4 shows a block diagram 400 of a device 405 that supports resource allocation for UCI with multiple scheduled transport blocks in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to resource allocation for UCI with multiple scheduled transport blocks). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to resource allocation for UCI with multiple scheduled transport blocks). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of resource allocation for UCI with multiple scheduled transport blocks as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication in accordance with examples as disclosed herein. For example, the communications manager 420 may be configured as or otherwise support a means for receiving a control message including scheduling for an UL-SCH associated with a set of multiple transport blocks. The communications manager 420 may be configured as or otherwise support a means for multiplexing UCI with the UL-SCH on one or more transport blocks of the set of multiple transport blocks based on the control message. The communications manager 420 may be configured as or otherwise support a means for calculating a first quantity of resources for the UCI and a second quantity of resources for the UCI based on the set of multiple transport blocks. The communications manager 420 may be configured as or otherwise support a means for calculating a minimum value between the first quantity of resources and the second quantity of resources. The communications manager 420 may be configured as or otherwise support a means for transmitting the UCI over the UL-SCH using a set of resources that corresponds to the minimum value.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for more efficient utilization of communication resources, increased throughput, and increased reliability.

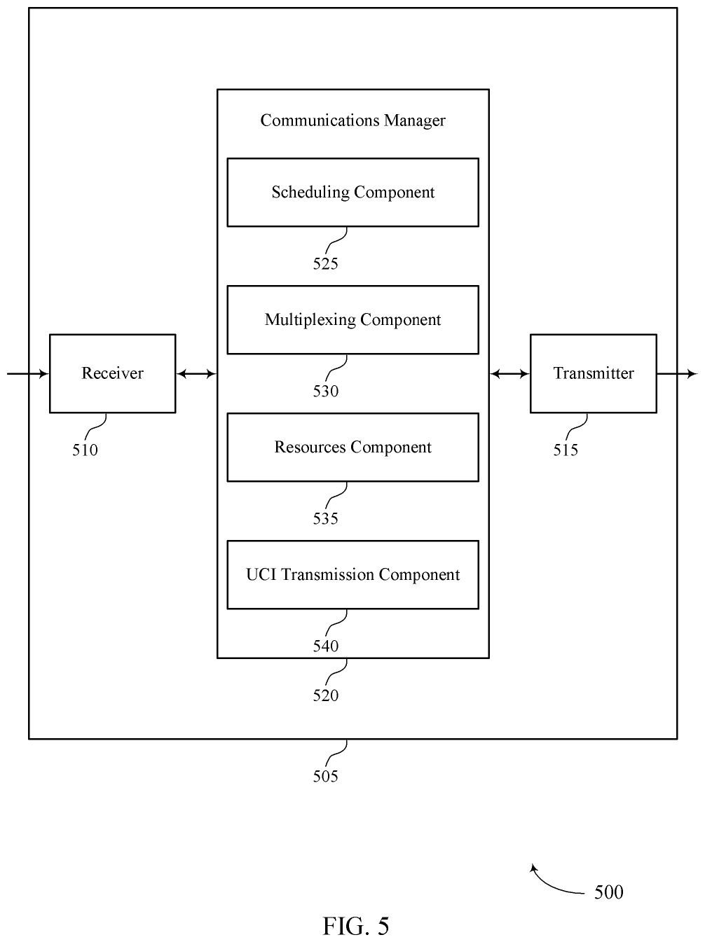

FIG. 5 shows a block diagram 500 of a device 505 that supports resource allocation for UCI with multiple scheduled transport blocks in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to resource allocation for UCI with multiple scheduled transport blocks). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to resource allocation for UCI with multiple scheduled transport blocks). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of resource allocation for UCI with multiple scheduled transport blocks as described herein. For example, the communications manager 520 may include a scheduling component 525, a multiplexing component 530, a resources component 535, a UCI transmission component 540, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. The scheduling component 525 may be configured as or otherwise support a means for receiving a control message including scheduling for an UL-SCH associated with a set of multiple transport blocks. The multiplexing component 530 may be configured as or otherwise support a means for multiplexing UCI with the UL-SCH on one or more transport blocks of the set of multiple transport blocks based on the control message. The resources component 535 may be configured as or otherwise support a means for calculating a first quantity of resources for the UCI and a second quantity of resources for the UCI based on the set of multiple transport blocks. The resources component 535 may be configured as or otherwise support a means for calculating a minimum value between the first quantity of resources and the second quantity of resources. The UCI transmission component 540 may be configured as or otherwise support a means for transmitting the UCI over the UL-SCH using a set of resources that corresponds to the minimum value.

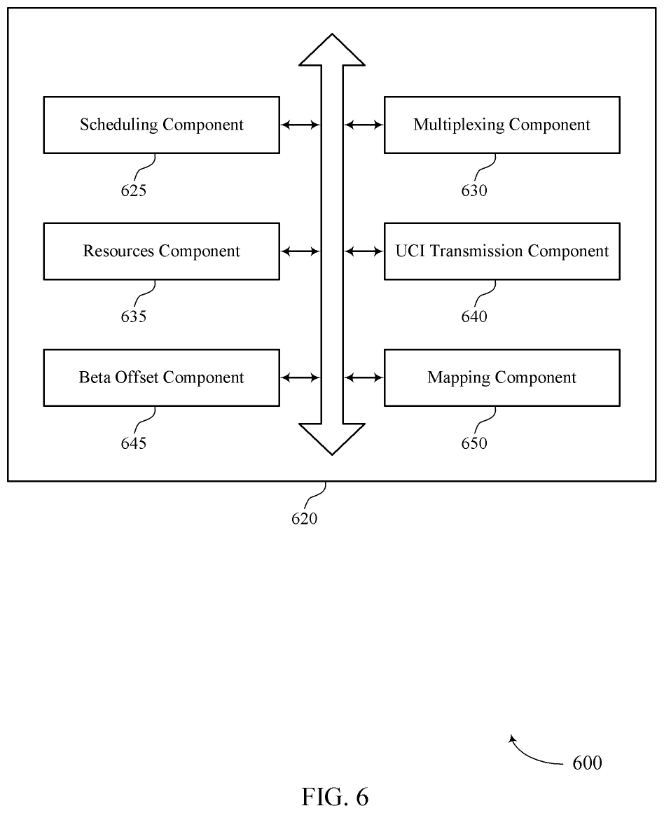

FIG. 6 shows a block diagram 600 of a communications manager 620 that supports resource allocation for UCI with multiple scheduled transport blocks in accordance with one or more aspects of the present disclosure. The communications manager 620 may be an example of aspects of a communications manager 420, a communications manager 520, or both, as described herein. The communications manager 620, or various components thereof, may be an example of means for performing various aspects of resource allocation for UCI with multiple scheduled transport blocks as described herein. For example, the communications manager 620 may include a scheduling component 625, a multiplexing component 630, a resources component 635, a UCI transmission component 640, a beta offset component 645, a mapping component 650, or any combination thereof. Each of these components may communicate, directly or indirectly, with one another (e.g., via one or more buses).

The communications manager 620 may support wireless communication in accordance with examples as disclosed herein. The scheduling component 625 may be configured as or otherwise support a means for receiving a control message including scheduling for an UL-SCH associated with a set of multiple transport blocks. The multiplexing component 630 may be configured as or otherwise support a means for multiplexing UCI with the UL-SCH on one or more transport blocks of the set of multiple transport blocks based on the control message. The resources component 635 may be configured as or otherwise support a means for calculating a first quantity of resources for the UCI and a second quantity of resources for the UCI based on the set of multiple transport blocks. In some examples, the resources component 635 may be configured as or otherwise support a means for calculating a minimum value between the first quantity of resources and the second quantity of resources. The UCI transmission component 640 may be configured as or otherwise support a means for transmitting the UCI over the UL-SCH using a set of resources that corresponds to the minimum value.

In some examples, to support multiplexing the UCI on the one or more transport blocks, the resources component 635 may be configured as or otherwise support a means for multiplexing the UCI on a transport block of the set of multiple transport blocks and calculating a quantity of code blocks and a size of the code blocks, the code blocks associated with the transport block of the set of multiple transport blocks on which the UCI is multiplexed, where calculating the first quantity of resources is further based on a sum of the size of each code block of the quantity of the code blocks.

In some examples, to support multiplexing the UCI on the one or more transport blocks, the resources component 635 may be configured as or otherwise support a means for multiplexing the UCI on the set of multiple transport blocks and calculating a quantity of code blocks and a size of the code blocks, the code blocks associated with the set of multiple transport blocks.

In some examples, to support calculating the first quantity of resources, the resources component 635 may be configured as or otherwise support a means for calculating a plurality of sums, wherein the plurality of sums comprises a sum of the size of each code block of the quantity of the code blocks for each transport block of the set of multiple transport blocks and combining each of the sums of the plurality of sums.

In some examples, to support multiplexing the UCI on the one or more transport blocks, the resources component 635 may be configured as or otherwise support a means for multiplexing the UCI on the set of multiple transport blocks and calculating a combination of a quantity of layers of each transport block of the set of multiple transport blocks. In some examples, to support multiplexing the UCI on the one or more transport blocks, the resources component 635 may be configured as or otherwise support a means for calculating a product of the combination and a maximum effective MCS value, where calculating the first quantity of resources is further based on the product.

In some examples, the resources component 635 may be configured as or otherwise support a means for calculating the maximum effective MCS value between each transport block of the plurality of transport blocks, where an effective MCS value for a transport block is calculated by calculating a combination of a size of each code block of a set of multiple code blocks associated with the transport block and calculating a separation of the combination by a quantity of layers of the transport block.

In some examples, to support multiplexing the UCI on the one or more transport blocks, the resources component 635 may be configured as or otherwise support a means for multiplexing the UCI on the set of multiple transport blocks and calculating a combination of a quantity of layers of each transport block of the set of multiple transport blocks. In some examples, to support multiplexing the UCI on the one or more transport blocks, the resources component 635 may be configured as or otherwise support a means for calculating a product of the combination and a minimum effective MCS value, where calculating the first quantity of resources is further based on the product.

In some examples, the resources component 635 may be configured as or otherwise support a means for calculating the minimum effective MCS value between each transport block of the set of multiple transport blocks, where an effective MCS value for a transport block is calculated by calculating a combination of a size of each code block of a set of multiple code blocks associated with the transport block and calculating a separation of the combination by a quantity of layers of the transport block.

In some examples, the beta offset component 645 may be configured as or otherwise support a means for receiving a second control message indicating a beta offset associated with the UCI, the control message including downlink control information, a medium access control-control element, radio resource control, or any combination thereof, where calculating the first quantity of resources is further based on the beta offset.

In some examples, to support multiplexing the UCI on the one or more transport blocks, the resources component 635 may be configured as or otherwise support a means for multiplexing one or more second UCI and first UCI on a same transport block, wherein the UCI comprises the first UCI and calculating a difference of a third quantity of resources available for UCI and a fourth quantity of resources associated with the one or more second UCI, where calculating the second quantity of resources is further based on the difference.

In some examples, the mapping component 650 may be configured as or otherwise support a means for determining a mapping indicating the one or more second UCI mapped to resources of the UL-SCH prior to the first UCI.

In some examples, to support multiplexing the UCI on the one or more transport blocks, the resources component 635 may be configured as or otherwise support a means for multiplexing one or more second UCI on one or more second transport blocks of the plurality of transport blocks, wherein the UCI comprises first UCI and calculating a difference of a third quantity of resources available for UCI and a fourth quantity of resources associated with the one or more second UCI, where calculating the second quantity of resources is further based on the difference.

In some examples, the mapping component 650 may be configured as or otherwise support a means for determining a mapping indicating the one or more second UCI mapped to resources of the UL-SCH prior to the first UCI.

In some examples, the first quantity of resources are a quantity of resources required to transmit the UCI and the second quantity of resources are a quantity of resources available to transmit the UCI.

In some examples, the control message includes downlink control information, radio resource control, or any combination thereof.

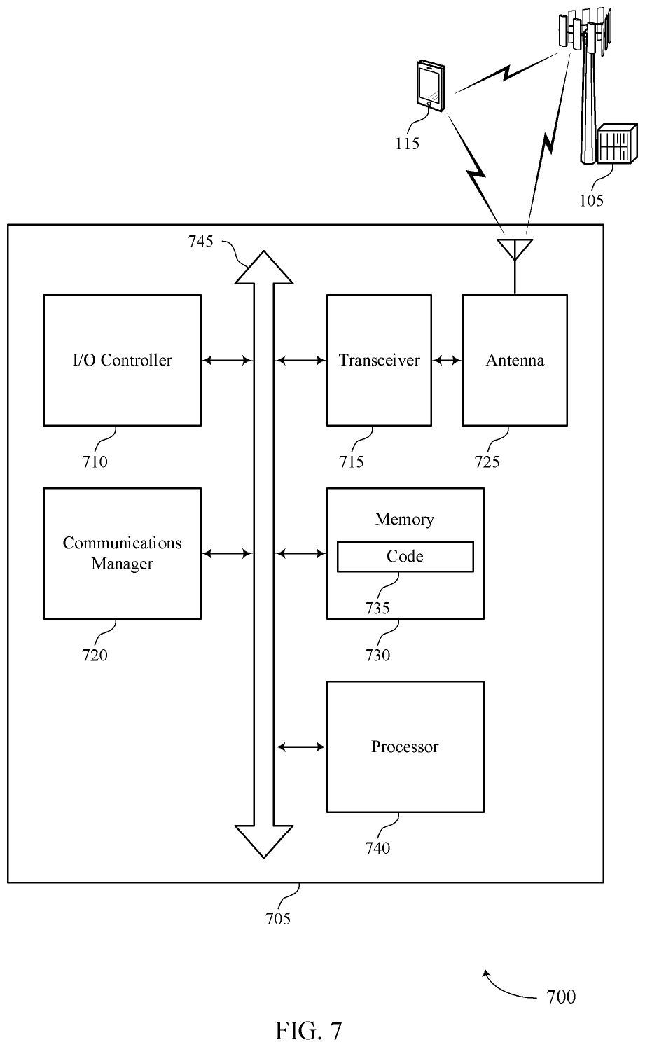

FIG. 7 shows a diagram of a system 700 including a device 705 that supports resource allocation for UCI with multiple scheduled transport blocks in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting resource allocation for UCI with multiple scheduled transport blocks). For example, the device 705 or a component of the device 705 may include a processor 740 and memory 730 coupled with or to the processor 740, the processor 740 and memory 730 configured to perform various functions described herein.

The communications manager 720 may support wireless communication in accordance with examples as disclosed herein. For example, the communications manager 720 may be configured as or otherwise support a means for receiving a control message including scheduling for an UL-SCH associated with a set of multiple transport blocks. The communications manager 720 may be configured as or otherwise support a means for multiplexing UCI with the UL-SCH on one or more transport blocks of the set of multiple transport blocks based on the control message. The communications manager 720 may be configured as or otherwise support a means for calculating a first quantity of resources for the UCI and a second quantity of resources for the UCI based on the set of multiple transport blocks. The communications manager 720 may be configured as or otherwise support a means for calculating a minimum value between the first quantity of resources and the second quantity of resources. The communications manager 720 may be configured as or otherwise support a means for transmitting the UCI over the UL-SCH using a set of resources that corresponds to the minimum value.

By including or configuring the communications manager 720 in accordance with examples as described herein, the device 705 may support techniques for more efficient utilization of communication resources, increased throughput, and increased reliability.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of resource allocation for UCI with multiple scheduled transport blocks as described herein, or the processor 740 and the memory 730 may be otherwise configured to perform or support such operations.

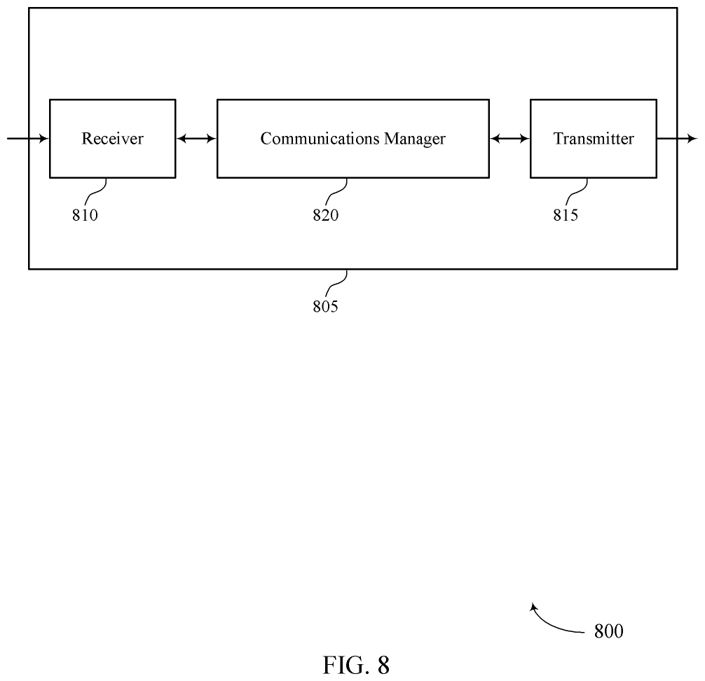

FIG. 8 shows a block diagram 800 of a device 805 that supports resource allocation for UCI with multiple scheduled transport blocks in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of resource allocation for UCI with multiple scheduled transport blocks as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. For example, the communications manager 820 may be configured as or otherwise support a means for outputting a control message including scheduling for an UL-SCH associated with a set of multiple transport blocks. The communications manager 820 may be configured as or otherwise support a means for multiplexing UCI with the UL-SCH on one or more transport blocks of the set of multiple transport blocks based on the control message. The communications manager 820 may be configured as or otherwise support a means for calculating a first quantity of resources for the UCI and a second quantity of resources for the UCI based on the set of multiple transport blocks. The communications manager 820 may be configured as or otherwise support a means for calculating a minimum value between the first quantity of resources and the second quantity of resources. The communications manager 820 may be configured as or otherwise support a means for obtaining the UCI over the UL-SCH using a set of resources that corresponds to the minimum value.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for more efficient utilization of communication resources, increased throughput, and increased reliability.

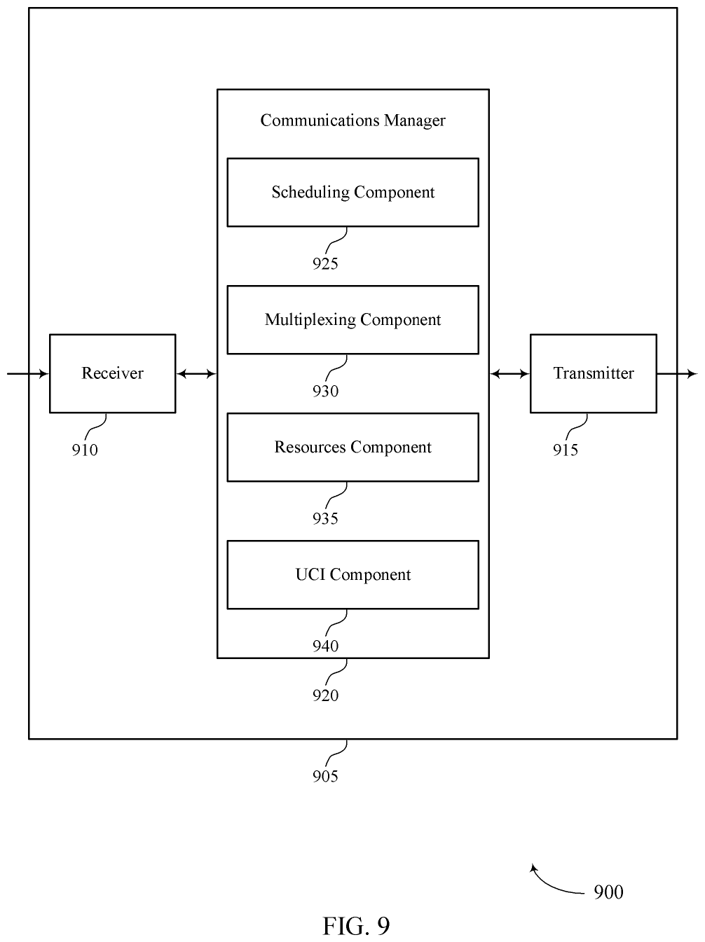

FIG. 9 shows a block diagram 900 of a device 905 that supports resource allocation for UCI with multiple scheduled transport blocks in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of resource allocation for UCI with multiple scheduled transport blocks as described herein. For example, the communications manager 920 may include a scheduling component 925, a multiplexing component 930, a resources component 935, a UCI component 940, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. The scheduling component 925 may be configured as or otherwise support a means for outputting a control message including scheduling for an UL-SCH associated with a set of multiple transport blocks. The multiplexing component 930 may be configured as or otherwise support a means for multiplexing UCI with the UL-SCH on one or more transport blocks of the set of multiple transport blocks based on the control message. The resources component 935 may be configured as or otherwise support a means for calculating a first quantity of resources for the UCI and a second quantity of resources for the UCI based on the set of multiple transport blocks. The resources component 935 may be configured as or otherwise support a means for calculating a minimum value between the first quantity of resources and the second quantity of resources. The UCI component 940 may be configured as or otherwise support a means for obtaining the UCI over the UL-SCH using a set of resources that corresponds to the minimum value.

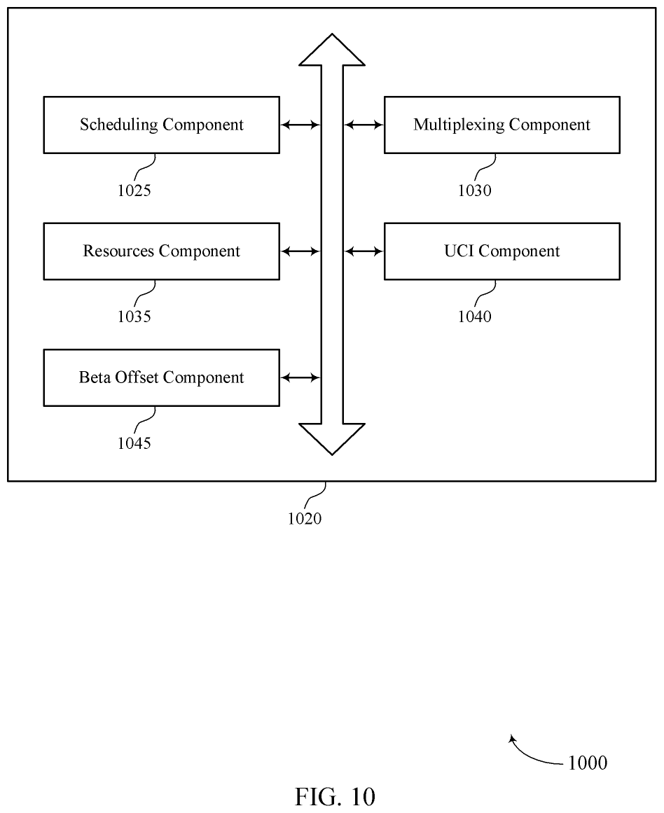

FIG. 10 shows a block diagram 1000 of a communications manager 1020 that supports resource allocation for UCI with multiple scheduled transport blocks in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of resource allocation for UCI with multiple scheduled transport blocks as described herein. For example, the communications manager 1020 may include a scheduling component 1025, a multiplexing component 1030, a resources component 1035, a UCI component 1040, a beta offset component 1045, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication in accordance with examples as disclosed herein. The scheduling component 1025 may be configured as or otherwise support a means for outputting a control message including scheduling for an UL-SCH associated with a set of multiple transport blocks. The multiplexing component 1030 may be configured as or otherwise support a means for multiplexing UCI with the UL-SCH on one or more transport blocks of the set of multiple transport blocks based on the control message. The resources component 1035 may be configured as or otherwise support a means for calculating a first quantity of resources for the UCI and a second quantity of resources for the UCI based on the set of multiple transport blocks. In some examples, the resources component 1035 may be configured as or otherwise support a means for calculating a minimum value between the first quantity of resources and the second quantity of resources. The UCI component 1040 may be configured as or otherwise support a means for obtaining the UCI over the UL-SCH using a set of resources that corresponds to the minimum value.

In some examples, to support multiplexing the UCI on the one or more transport blocks, the resources component 1035 may be configured as or otherwise support a means for multiplexing the UCI on a transport block of the set of multiple transport blocks and calculating a quantity of code blocks and a size of the code blocks, the code blocks associated with the transport block of the set of multiple transport blocks on which the UCI is multiplexed, where calculating the first quantity of resources is further based on a sum of the size of each code block of the quantity of the code blocks.

In some examples, to support multiplexing the UCI on the one or more transport blocks, the resources component 1035 may be configured as or otherwise support a means for multiplexing the UCI on the set of multiple transport blocks and calculating a quantity of code blocks and a size of the code blocks, the code blocks associated with the set of multiple transport blocks.

In some examples, to support calculating the first quantity of resources, the resources component 1035 may be configured as or otherwise support a means for calculating a plurality of sums, wherein the plurality of sums comprises a sum of the size of each code block of the quantity of the code blocks for each transport block of the set of multiple transport blocks and combining each of the sums of the plurality of sums.

In some examples, to support multiplexing the UCI on the one or more transport blocks, the resources component 1035 may be configured as or otherwise support a means for multiplexing the UCI on the set of multiple transport blocks and calculating a combination of a quantity of layers of each transport block of the set of multiple transport blocks. In some examples, to support multiplexing the UCI on the one or more transport blocks, the resources component 1035 may be configured as or otherwise support a means for calculating a product of the combination and a maximum effective MCS value, where calculating the first quantity of resources is further based on the product.

In some examples, the resources component 1035 may be configured as or otherwise support a means for calculating the maximum effective MCS value between each transport block of the set of multiple transport blocks, where an effective MCS value for a transport block is calculated by calculating a combination of a size of each code block of a set of multiple code blocks associated with the transport block and calculating a separation of the combination by a quantity of layers of the transport block.

In some examples, to support multiplexing the UCI on the one or more transport blocks, the resources component 1035 may be configured as or otherwise support a means for multiplexing the UCI on the set of multiple transport blocks and calculating a combination of a quantity of layers of each transport block of the set of multiple transport blocks. In some examples, to support multiplexing the UCI on the one or more transport blocks, the resources component 1035 may be configured as or otherwise support a means for calculating a product of the combination and a minimum effective MCS value, where calculating the first quantity of resources is further based on the product.

In some examples, the resources component 1035 may be configured as or otherwise support a means for calculating the minimum effective MCS value between each transport block of the set of multiple transport blocks, where an effective MCS value for a transport block is calculated by calculating a combination of a size of each code block of a set of multiple code blocks associated with the transport block and calculating a separation of the combination by a quantity of layers of the transport block.

In some examples, the beta offset component 1045 may be configured as or otherwise support a means for outputting a second control message indicating a beta offset associated with the UCI, the control message including downlink control information, a medium access control-control element, radio resource control, or any combination thereof, where calculating the first quantity of resources is further based on the beta offset.

In some examples, to support multiplexing the UCI on the one or more transport blocks, the resources component 1035 may be configured as or otherwise support a means for multiplexing one or more second UCI and first UCI on a same transport block, where the UCI comprises the first UCI and calculating a difference of a third quantity of resources available for UCI and a fourth quantity of resources associated with the one or more second UCI, where calculating the second quantity of resources is further based on the difference.

In some examples, to support multiplexing the UCI on the one or more transport blocks, the resources component 1035 may be configured as or otherwise support a means for multiplexing one or more second UCI on one or more second transport blocks of the plurality of transport blocks, where the UCI comprises first UCI and calculating a difference of a third quantity of resources available for UCI and a fourth quantity of resources associated with the one or more second UCI, where calculating the second quantity of resources is further based on the difference.

In some examples, the first quantity of resources are a quantity of resources required to transmit the UCI and the second quantity of resources are a quantity of resources available to transmit the UCI.

In some examples, the control message includes downlink control information, radio resource control, or any combination thereof.

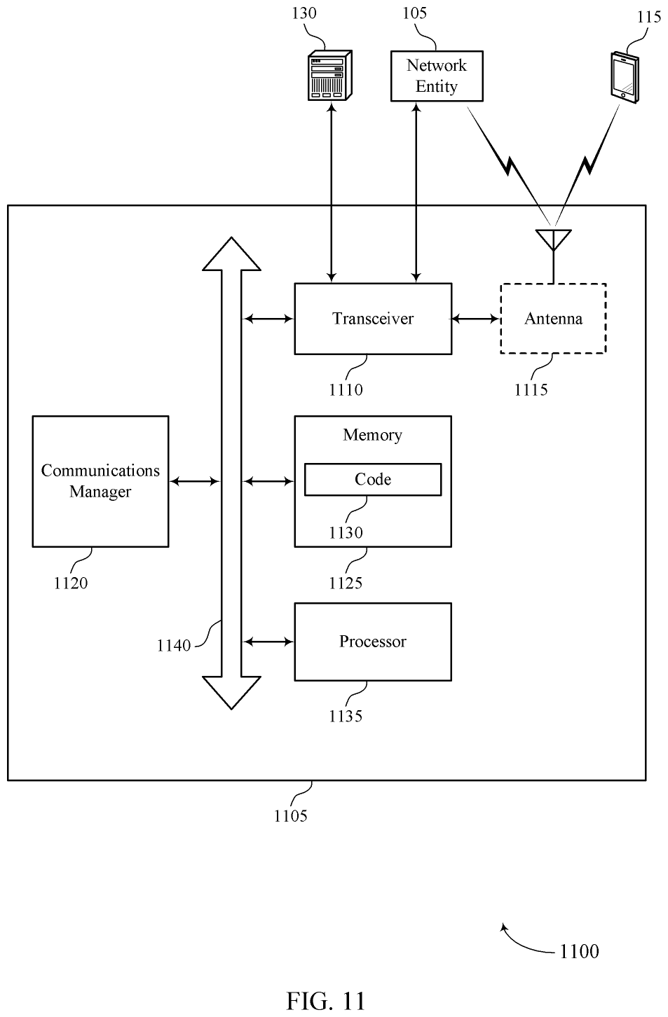

FIG. 11 shows a diagram of a system 1100 including a device 1105 that supports resource allocation for UCI with multiple scheduled transport blocks in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. The transceiver 1110, or the transceiver 1110 and one or more antennas 1115 or wired interfaces, where applicable, may be an example of a transmitter 815, a transmitter 915, a receiver 810, a receiver 910, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting resource allocation for UCI with multiple scheduled transport blocks). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication in accordance with examples as disclosed herein. For example, the communications manager 1120 may be configured as or otherwise support a means for outputting a control message including scheduling for an UL-SCH associated with a set of multiple transport blocks. The communications manager 1120 may be configured as or otherwise support a means for multiplexing UCI with the UL-SCH on one or more transport blocks of the set of multiple transport blocks based on the control message. The communications manager 1120 may be configured as or otherwise support a means for calculating a first quantity of resources for the UCI and a second quantity of resources for the UCI based on the set of multiple transport blocks. The communications manager 1120 may be configured as or otherwise support a means for calculating a minimum value between the first quantity of resources and the second quantity of resources. The communications manager 1120 may be configured as or otherwise support a means for obtaining the UCI over the UL-SCH using a set of resources that corresponds to the minimum value.

By including or configuring the communications manager 1120 in accordance with examples as described herein, the device 1105 may support techniques for more efficient utilization of communication resources, increased throughput, and increased reliability.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the processor 1135, the memory 1125, the code 1130, the transceiver 1110, or any combination thereof. For example, the code 1130 may include instructions executable by the processor 1135 to cause the device 1105 to perform various aspects of resource allocation for UCI with multiple scheduled transport blocks as described herein, or the processor 1135 and the memory 1125 may be otherwise configured to perform or support such operations.

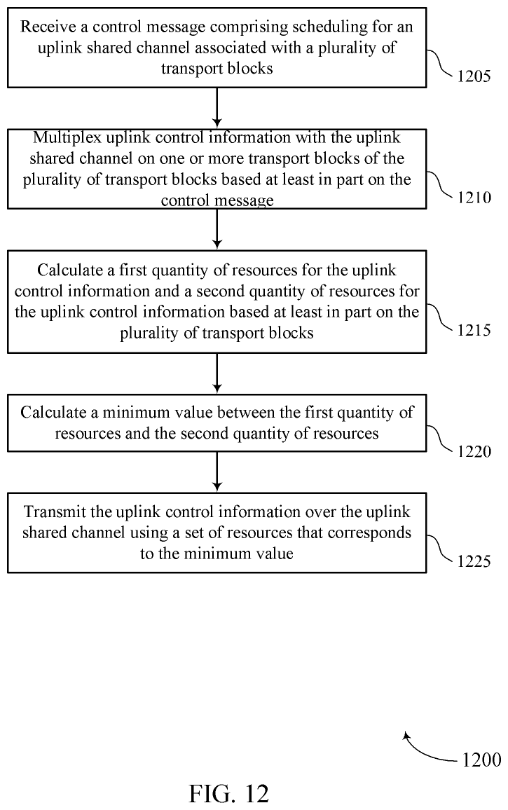

FIG. 12 shows a flowchart illustrating a method 1200 that supports resource allocation for UCI with multiple scheduled transport blocks in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving a control message including scheduling for an UL-SCH associated with a set of multiple transport blocks. The operations of 1205 may be performed in accordance with examples as disclosed herein. In some examples, aspects of the operations of 1205 may be performed by a scheduling component 625 as described with reference to FIG. 6.

At 1210, the method may include multiplexing UCI with the UL-SCH on one or more transport blocks of the set of multiple transport blocks based on the control message. The operations of 1210 may be performed in accordance with examples as disclosed herein. In some examples, aspects of the operations of 1210 may be performed by a multiplexing component 630 as described with reference to FIG. 6.

At 1215, the method may include calculating a first quantity of resources for the UCI and a second quantity of resources for the UCI based on the set of multiple transport blocks. The operations of 1215 may be performed in accordance with examples as disclosed herein. In some examples, aspects of the operations of 1215 may be performed by a resources component 635 as described with reference to FIG. 6.

At 1220, the method may include calculating a minimum value between the first quantity of resources and the second quantity of resources. The operations of 1220 may be performed in accordance with examples as disclosed herein. In some examples, aspects of the operations of 1220 may be performed by a resources component 635 as described with reference to FIG. 6.

At 1225, the method may include transmitting the UCI over the UL-SCH using a set of resources that corresponds to the minimum value. The operations of 1225 may be performed in accordance with examples as disclosed herein. In some examples, aspects of the operations of 1225 may be performed by a UCI transmission component 640 as described with reference to FIG. 6.

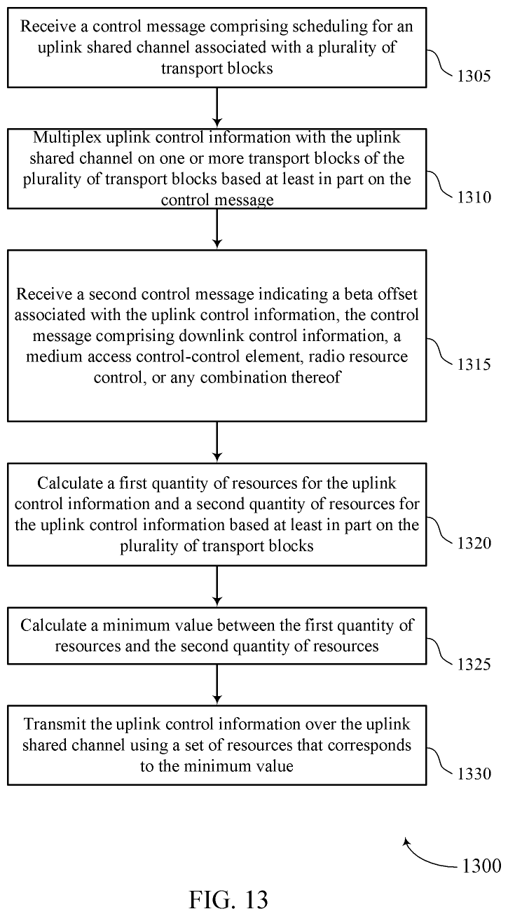

FIG. 13 shows a flowchart illustrating a method 1300 that supports resource allocation for UCI with multiple scheduled transport blocks in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving a control message including scheduling for an UL-SCH associated with a set of multiple transport blocks. The operations of 1305 may be performed in accordance with examples as disclosed herein. In some examples, aspects of the operations of 1305 may be performed by a scheduling component 625 as described with reference to FIG. 6.

At 1310, the method may include multiplexing UCI with the UL-SCH on one or more transport blocks of the set of multiple transport blocks based on the control message. The operations of 1310 may be performed in accordance with examples as disclosed herein. In some examples, aspects of the operations of 1310 may be performed by a multiplexing component 630 as described with reference to FIG. 6.

At 1315, the method may include receiving a second control message indicating a beta offset associated with the UCI, the control message including downlink control information, a medium access control-control element, radio resource control, or any combination thereof. The operations of 1315 may be performed in accordance with examples as disclosed herein. In some examples, aspects of the operations of 1315 may be performed by a beta offset component 645 as described with reference to FIG. 6.

At 1320, the method may include calculating a first quantity of resources for the UCI and a second quantity of resources for the UCI based on the set of multiple transport blocks. The operations of 1320 may be performed in accordance with examples as disclosed herein. In some examples, aspects of the operations of 1320 may be performed by a resources component 635 as described with reference to FIG. 6.

At 1325, the method may include calculating a minimum value between the first quantity of resources and the second quantity of resources. The operations of 1325 may be performed in accordance with examples as disclosed herein. In some examples, aspects of the operations of 1325 may be performed by a resources component 635 as described with reference to FIG. 6.

At 1330, the method may include transmitting the UCI over the UL-SCH using a set of resources that corresponds to the minimum value. The operations of 1330 may be performed in accordance with examples as disclosed herein. In some examples, aspects of the operations of 1330 may be performed by a UCI transmission component 640 as described with reference to FIG. 6.

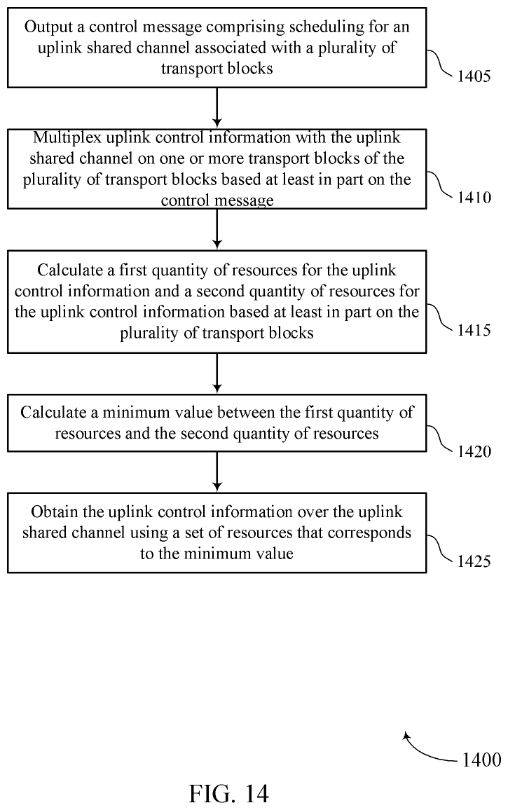

FIG. 14 shows a flowchart illustrating a method 1400 that supports resource allocation for UCI with multiple scheduled transport blocks in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include outputting a control message including scheduling for an UL-SCH associated with a set of multiple transport blocks. The operations of 1405 may be performed in accordance with examples as disclosed herein. In some examples, aspects of the operations of 1405 may be performed by a scheduling component 1025 as described with reference to FIG. 10.

At 1410, the method may include multiplexing UCI with the UL-SCH on one or more transport blocks of the set of multiple transport blocks based on the control message. The operations of 1410 may be performed in accordance with examples as disclosed herein. In some examples, aspects of the operations of 1410 may be performed by a multiplexing component 1030 as described with reference to FIG. 10.

At 1415, the method may include calculating a first quantity of resources for the UCI and a second quantity of resources for the UCI based on the set of multiple transport blocks. The operations of 1415 may be performed in accordance with examples as disclosed herein. In some examples, aspects of the operations of 1415 may be performed by a resources component 1035 as described with reference to FIG. 10.

At 1420, the method may include calculating a minimum value between the first quantity of resources and the second quantity of resources. The operations of 1420 may be performed in accordance with examples as disclosed herein. In some examples, aspects of the operations of 1420 may be performed by a resources component 1035 as described with reference to FIG. 10.

At 1425, the method may include obtaining the UCI over the UL-SCH using a set of resources that corresponds to the minimum value. The operations of 1425 may be performed in accordance with examples as disclosed herein. In some examples, aspects of the operations of 1425 may be performed by a UCI component 1040 as described with reference to FIG. 10.

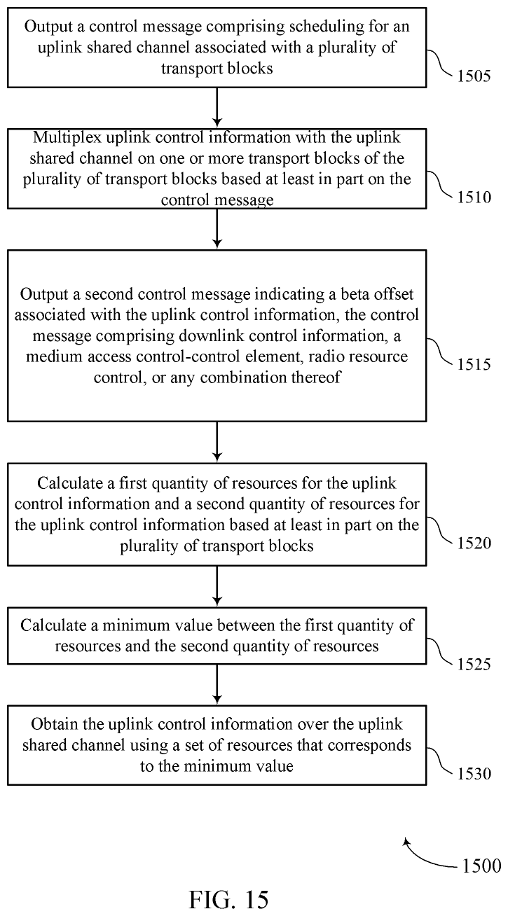

FIG. 15 shows a flowchart illustrating a method 1500 that supports resource allocation for UCI with multiple scheduled transport blocks in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include outputting a control message including scheduling for an UL-SCH associated with a set of multiple transport blocks. The operations of 1505 may be performed in accordance with examples as disclosed herein. In some examples, aspects of the operations of 1505 may be performed by a scheduling component 1025 as described with reference to FIG. 10.

At 1510, the method may include multiplexing UCI with the UL-SCH on one or more transport blocks of the set of multiple transport blocks based on the control message. The operations of 1510 may be performed in accordance with examples as disclosed herein. In some examples, aspects of the operations of 1510 may be performed by a multiplexing component 1030 as described with reference to FIG. 10.

At 1515, the method may include outputting a second control message indicating a beta offset associated with the UCI, the control message including downlink control information, a medium access control-control element, radio resource control, or any combination thereof. The operations of 1515 may be performed in accordance with examples as disclosed herein. In some examples, aspects of the operations of 1515 may be performed by a beta offset component 1045 as described with reference to FIG. 10.

At 1520, the method may include calculating a first quantity of resources for the UCI and a second quantity of resources for the UCI based on the set of multiple transport blocks. The operations of 1520 may be performed in accordance with examples as disclosed herein. In some examples, aspects of the operations of 1520 may be performed by a resources component 1035 as described with reference to FIG. 10.

At 1525, the method may include calculating a minimum value between the first quantity of resources and the second quantity of resources. The operations of 1525 may be performed in accordance with examples as disclosed herein. In some examples, aspects of the operations of 1525 may be performed by a resources component 1035 as described with reference to FIG. 10.

At 1530, the method may include obtaining the UCI over the UL-SCH using a set of resources that corresponds to the minimum value. The operations of 1530 may be performed in accordance with examples as disclosed herein. In some examples, aspects of the operations of 1530 may be performed by a UCI component 1040 as described with reference to FIG. 10.

The following provides an overview of aspects of the present disclosure:

Aspect 1: A method for wireless communication, comprising: receiving a control message comprising scheduling for an UL-SCH associated with a plurality of transport blocks; multiplexing UCI with the UL-SCH on one or more transport blocks of the plurality of transport blocks based at least in part on the control message; calculating a first quantity of resources for the UCI and a second quantity of resources for the UCI based at least in part on the plurality of transport blocks; calculating a minimum value between the first quantity of resources and the second quantity of resources; and transmitting the UCI over the UL-SCH using a set of resources that corresponds to the minimum value.

Aspect 2: The method of aspect 1, wherein multiplexing the UCI on the one or more transport blocks comprises multiplexing the UCI on a transport block of the plurality of transport blocks, and further comprising: calculating a quantity of code blocks and a size of the code blocks, the code blocks associated with the transport block of the plurality of transport blocks on which the UCI is multiplexed, wherein calculating the first quantity of resources is further based at least in part on a sum of the size of each code block of the quantity of the code blocks.

Aspect 3: The method of any of aspects 1 through 2, wherein multiplexing the UCI on the one or more transport blocks comprises multiplexing the UCI on the plurality of transport blocks, and further comprising: calculating a quantity of code blocks and a size of the code blocks, the code blocks associated with the plurality of transport blocks.

Aspect 4: The method of aspect 3, wherein calculating the first quantity of resources further comprises: calculating a plurality of sums, wherein the plurality of sums comprises a sum of the size of each code block of the quantity of the code blocks for each transport block of the plurality of transport blocks; and combining each of the sums of the plurality of sums.

Aspect 5: The method of any of aspects 1 through 4, wherein multiplexing the UCI on the one or more transport blocks comprises multiplexing the UCI on the plurality of transport blocks, and further comprising: calculating a combination of a quantity of layers of each transport block of the plurality of transport blocks; and calculating a product of the combination and a maximum effective MCS value, wherein calculating the first quantity of resources is further based at least in part on the product.

Aspect 6: The method of aspect 5, further comprising calculating the maximum effective MCS value between each transport block of the plurality of transport blocks, wherein an effective MCS value for a transport block is calculated by: calculating a combination of a size of each code block of a plurality of code blocks associated with the transport block; and calculating a separation of the combination by a quantity of layers of the transport block.

Aspect 7: The method of any of aspects 1 through 6, wherein multiplexing the UCI on the one or more transport blocks comprises multiplexing the UCI on the plurality of transport blocks, and further comprising: calculating a combination of a quantity of layers of each transport block of the plurality of transport blocks; and calculating a product of the combination and a minimum effective MCS value, wherein calculating the first quantity of resources is further based at least in part on the product.

Aspect 8: The method of aspect 7, further comprising: calculating the minimum effective MCS value between each transport block of the plurality of transport blocks, wherein an effective MCS value for a transport block is calculated by: calculating a combination of a size of each code block of a plurality of code blocks associated with the transport block; and calculating a separation of the combination by a quantity of layers of the transport block.

Aspect 9: The method of any of aspects 1 through 8, further comprising: receiving a second control message indicating a beta offset associated with the UCI, the control message comprising downlink control information, a medium access control-control element, radio resource control, or any combination thereof, wherein calculating the first quantity of resources is further based at least in part on the beta offset.

Aspect 10: The method of any of aspects 1 through 9, wherein multiplexing the UCI on the one or more transport blocks comprises multiplexing one or more second UCI and first UCI on a same transport block, wherein the UCI comprises the first UCI, and further comprising: calculating a difference of a third quantity of resources available for UCI and a fourth quantity of resources associated with the one or more second UCI, wherein calculating the second quantity of resources is further based at least in part on the difference.

Aspect 11: The method of aspect 10, further comprising: determining a mapping indicating the one or more second UCI mapped to resources of the UL-SCH prior to the first UCI.

Aspect 12: The method of any of aspects 1 through 11, wherein multiplexing the UCI on the one or more transport blocks comprises multiplexing one or more second UCI on one or more second transport blocks of the plurality of transport blocks, wherein the UCI comprises first UCI, and further comprising: calculating a difference of a third quantity of resources available for UCI and a fourth quantity of resources associated with the one or more second UCI, wherein calculating the second quantity of resources is further based at least in part on the difference.

Aspect 13: The method of aspect 12, further comprising: determining a mapping indicating the one or more second UCI mapped to resources of the UL-SCH prior to the first UCI.

Aspect 14: The method of any of aspects 1 through 13, wherein the first quantity of resources are a quantity of resources required to transmit the UCI and the second quantity of resources are a quantity of resources available to transmit the UCI.

Aspect 15: The method of any of aspects 1 through 14, wherein the control message comprises downlink control information, radio resource control, or any combination thereof.

Aspect 16: A method for wireless communication, comprising: outputting a control message comprising scheduling for an UL-SCH associated with a plurality of transport blocks; multiplexing UCI on one or more transport blocks of the plurality of transport blocks based at least in part on the control message; calculating a first quantity of resources for the UCI and a second quantity of resources for the UCI based at least in part on the plurality of transport blocks; calculating a minimum value between the first quantity of resources and the second quantity of resources; and obtaining the UCI over the UL-SCH using a set of resources that corresponds to the minimum value.

Aspect 17: The method of aspect 16, wherein multiplexing the UCI on the one or more transport blocks comprises multiplexing the UCI on a transport block of the plurality of transport blocks, and further comprising: calculating a quantity of code blocks and a size of the code blocks, the code blocks associated with the transport block of the plurality of transport blocks on which the UCI is multiplexed, wherein calculating the first quantity of resources is further based at least in part on a sum of the size of each code block of the quantity of the code blocks.

Aspect 18: The method of any of aspects 16 through 17, wherein multiplexing the UCI on the one or more transport blocks comprises multiplexing the UCI on the plurality of transport blocks, and further comprising: calculating a quantity of code blocks and a size of the code blocks, the code blocks associated with the plurality of transport blocks.

Aspect 19: The method of aspect 18, wherein calculating the first quantity of resources further comprises: calculating a sum of the size of each code block of the quantity of the code blocks for each transport block of the plurality of transport blocks and combining each of the sums.

Aspect 20: The method of any of aspects 16 through 19, wherein multiplexing the UCI on the one or more transport blocks comprises multiplexing the UCI on the plurality of transport blocks, and further comprising: calculating a combination of a quantity of layers of each transport block of the plurality of transport blocks; and calculating a product of the combination and a maximum effective MCS value, wherein calculating the first quantity of resources is further based at least in part on the product.

Aspect 21: The method of aspect 20, further comprising: calculating the maximum effective MCS value between each transport block of the plurality of transport blocks, wherein an effective MCS value for a transport block is calculated by: calculating a combination of a size of each code block of a plurality of code blocks associated with the transport block; and calculating a separation of the combination by a quantity of layers of the transport block.

Aspect 22: The method of any of aspects 16 through 21, wherein multiplexing the UCI on the one or more transport blocks comprises multiplexing the UCI on the plurality of transport blocks, and further comprising: calculating a combination of a quantity of layers of each transport block of the plurality of transport blocks; and calculating a product of the combination and a minimum effective MCS value, wherein calculating the first quantity of resources is further based at least in part on the product.

Aspect 23: The method of aspect 22, further comprising: calculating the minimum effective MCS value between each transport block of the plurality of transport blocks, wherein an effective MCS value for a transport block is calculated by: calculating a combination of a size of each code block of a plurality of code blocks associated with the transport block; and calculating a separation of the combination by a quantity of layers of the transport block.

Aspect 24: The method of any of aspects 16 through 23, further comprising: outputting a second control message indicating a beta offset associated with the UCI, the control message comprising downlink control information, a medium access control-control element, radio resource control, or any combination thereof, wherein calculating the first quantity of resources is further based at least in part on the beta offset.

Aspect 25: The method of any of aspects 16 through 24, wherein multiplexing the UCI on the one or more transport blocks comprises multiplexing one or more second UCI and first UCI on a same transport block, wherein the UCI comprises the first UCI, and further comprising: calculating a difference of a third quantity of resources available for UCI and a fourth quantity of resources associated with the one or more second UCI, wherein calculating the second quantity of resources is further based at least in part on the difference.

Aspect 26: The method of any of aspects 16 through 25, wherein multiplexing the UCI on the one or more transport blocks comprises multiplexing one or more second UCI on one or more second transport blocks of the plurality of transport blocks, wherein the UCI comprises first UCI, and further comprising: calculating a difference of a third quantity of resources available for UCI and a fourth quantity of resources associated with the one or more second UCI, wherein calculating the second quantity of resources is further based at least in part on the difference.

Aspect 27: The method of any of aspects 16 through 26, wherein the first quantity of resources are a quantity of resources required to transmit the UCI and the second quantity of resources are a quantity of resources available to transmit the UCI.

Aspect 28: The method of any of aspects 16 through 27, wherein the control message comprises downlink control information, radio resource control, or any combination thereof.

Aspect 29: An apparatus for wireless communication, comprising a processor; memory coupled with the processor; and instructions stored in the memory and executable by the processor to cause the apparatus to perform a method of any of aspects 1 through 15.

Aspect 30: An apparatus for wireless communication, comprising at least one means for performing a method of any of aspects 1 through 15.

Aspect 31: A non-transitory computer-readable medium storing code for wireless communication, the code comprising instructions executable by a processor to perform a method of any of aspects 1 through 15.

Aspect 32: An apparatus for wireless communication, comprising a processor; memory coupled with the processor; and instructions stored in the memory and executable by the processor to cause the apparatus to perform a method of any of aspects 16 through 28.

Aspect 33: An apparatus for wireless communication, comprising at least one means for performing a method of any of aspects 16 through 28.

Aspect 34: A non-transitory computer-readable medium storing code for wireless communication, the code comprising instructions executable by a processor to perform a method of any of aspects 16 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc, in which case disks may reproduce data magnetically, whereas discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

Also, as used herein, the phrase “a set” shall be construed as including the possibility of a set with one member. That is, the phrase “a set” shall be construed in the same manner as “one or more.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
a processor;
memory coupled with the processor; and
instructions stored in the memory and executable by the processor to cause the apparatus to:
receive a control message comprising scheduling for an uplink shared channel associated with a plurality of transport blocks;
multiplex uplink control information with the uplink shared channel on one or more transport blocks of the plurality of transport blocks based at least in part on the control message;
calculate a first quantity of resources for the uplink control information and a second quantity of resources for the uplink control information based at least in part on the plurality of transport blocks;
calculate a minimum value between the first quantity of resources and the second quantity of resources; and
transmit the uplink control information over the uplink shared channel using a set of resources that corresponds to the minimum value.

2. The apparatus of claim 1, wherein the instructions to multiplex the uplink control information on the one or more transport blocks are further executable by the processor to cause the apparatus to multiplex the uplink control information on a transport block of the plurality of transport blocks, and the instructions are further executable by the processor to cause the apparatus to:
calculate a quantity of code blocks and a size of the code blocks, the code blocks associated with the transport block of the plurality of transport blocks on which the uplink control information is multiplexed, wherein the instructions executable by the processor to cause the apparatus to calculate the first quantity of resources are further based at least in part on a sum of the size of each code block of the quantity of the code blocks.

3. The apparatus of claim 1, wherein the instructions to multiplex the uplink control information on the one or more transport blocks are further executable by the processor to cause the apparatus to multiplex the uplink control information on the plurality of transport blocks, and the instructions are further executable by the processor to cause the apparatus to:
calculate a quantity of code blocks and a size of the code blocks, the code blocks associated with the plurality of transport blocks.

4. The apparatus of claim 3, wherein the instructions to calculate the first quantity of resources are further executable by the processor to cause the apparatus to:
calculate a plurality of sums, wherein the plurality of sums comprises a sum of the size of each code block of the quantity of the code blocks for each transport block of the plurality of transport blocks; and
combine each of the sums of the plurality of sums.

5. The apparatus of claim 1, wherein the instructions to multiplex the uplink control information on the one or more transport blocks are further executable by the processor to cause the apparatus to multiplex the uplink control information on the plurality of transport blocks, and the instructions are further executable by the processor to cause the apparatus to:
calculate a combination of a quantity of layers of each transport block of the plurality of transport blocks; and
calculate a product of the combination and a maximum effective modulation and coding scheme value, wherein the instructions executable by the processor to cause the apparatus to calculate the first quantity of resources are further based at least in part on the product.

6. The apparatus of claim 5, wherein the instructions are further executable by the processor to cause the apparatus to:
calculate the maximum effective modulation and coding scheme value between each transport block of the plurality of transport blocks, wherein an effective modulation and coding scheme value for a transport block is calculated by:
calculating a combination of a size of each code block of a plurality of code blocks associated with the transport block; and
calculating a separation of the combination by a quantity of layers of the transport block.

7. The apparatus of claim 1, wherein the instructions to multiplex the uplink control information on the one or more transport blocks are further executable by the processor to cause the apparatus to multiplex the uplink control information on the plurality of transport blocks, and the instructions are further executable by the processor to cause the apparatus to:
calculate a combination of a quantity of layers of each transport block of the plurality of transport blocks; and
calculate a product of the combination and a minimum effective modulation and coding scheme value, wherein the instructions executable by the processor to cause the apparatus to calculate the first quantity of resources are further based at least in part on the product.

8. The apparatus of claim 7, wherein the instructions are further executable by the processor to cause the apparatus to:
calculate the minimum effective modulation and coding scheme value between each transport block of the plurality of transport blocks, wherein an effective modulation and coding scheme value for a transport block is calculated by:
calculating a combination of a size of each code block of a plurality of code blocks associated with the transport block; and
calculating a separation of the combination by a quantity of layers of the transport block.

9. The apparatus of claim 1, wherein the instructions are further executable by the processor to cause the apparatus to:
receive a second control message indicating a beta offset associated with the uplink control information, the control message comprising downlink control information, a medium access control-control element, radio resource control, or any combination thereof, wherein the instructions executable by the processor to cause the apparatus to calculate the first quantity of resources are further based at least in part on the beta offset.

10. The apparatus of claim 1, wherein the instructions to multiplex the uplink control information on the one or more transport blocks are further executable by the processor to cause the apparatus to multiplex one or more second uplink control information and first uplink control information on a same transport block, wherein the uplink control information comprises the first uplink control information, and the instructions are further executable by the processor to cause the apparatus to:
calculate a difference of a third quantity of resources available for uplink control information and a fourth quantity of resources associated with the one or more second uplink control information, wherein the instructions executable by the processor to cause the apparatus to calculate the second quantity of resources are further based at least in part on the difference.

11. The apparatus of claim 10, wherein the instructions are further executable by the processor to cause the apparatus to:
determine a mapping indicating the one or more second uplink control information mapped to resources of the uplink shared channel prior to the first uplink control information.

12. The apparatus of claim 1, wherein the instructions to multiplex the uplink control information on the one or more transport blocks are further executable by the processor to cause the apparatus to multiplex one or more second uplink control information on one or more second transport blocks of the plurality of transport blocks, wherein the uplink control information comprises first uplink control information, and the instructions are further executable by the processor to cause the apparatus to:
calculate a difference of a third quantity of resources available for uplink control information and a fourth quantity of resources associated with the one or more second uplink control information, wherein the instructions executable by the processor to cause the apparatus to calculate the second quantity of resources are further based at least in part on the difference.

13. The apparatus of claim 12, wherein the instructions are further executable by the processor to cause the apparatus to:
determine a mapping indicating the one or more second uplink control information mapped to resources of the uplink shared channel prior to the first uplink control information.

14. The apparatus of claim 1, wherein the first quantity of resources are a quantity of resources required to transmit the uplink control information and the second quantity of resources are a quantity of resources available to transmit the uplink control information.

15. The apparatus of claim 1, wherein the control message comprises downlink control information, radio resource control, or any combination thereof.

16. An apparatus for wireless communication, comprising:
a processor;
memory coupled with the processor; and
instructions stored in the memory and executable by the processor to cause the apparatus to:
output a control message comprising scheduling for an uplink shared channel associated with a plurality of transport blocks;
multiplex uplink control information with the uplink shared channel on one or more transport blocks of the plurality of transport blocks based at least in part on the control message;
calculate a first quantity of resources for the uplink control information and a second quantity of resources for the uplink control information based at least in part on the plurality of transport blocks;
calculate a minimum value between the first quantity of resources and the second quantity of resources; and
obtain the uplink control information over the uplink shared channel using a set of resources that corresponds to the minimum value.

17. The apparatus of claim 16, wherein the instructions to multiplex the uplink control information on the one or more transport blocks are further executable by the processor to cause the apparatus to multiplex the uplink control information on a transport block of the plurality of transport blocks, and the instructions are further executable by the processor to cause the apparatus to:
calculate a quantity of code blocks and a size of the code blocks, the code blocks associated with the transport block of the plurality of transport blocks on which the uplink control information is multiplexed, wherein the instructions executable by the processor to cause the apparatus to calculate the first quantity of resources are further based at least in part on a sum of the size of each code block of the quantity of the code blocks.

18. The apparatus of claim 16, wherein the instructions to multiplex the uplink control information on the one or more transport blocks are further executable by the processor to cause the apparatus to multiplex the uplink control information on the plurality of transport blocks, and the instructions are further executable by the processor to cause the apparatus to:
calculate a quantity of code blocks and a size of the code blocks, the code blocks associated with the plurality of transport blocks.

19. The apparatus of claim 18, wherein the instructions to calculate the first quantity of resources are further executable by the processor to cause the apparatus to:
calculate a plurality of sums, wherein the plurality of sums comprises a sum of the size of each code block of the quantity of the code blocks for each transport block of the plurality of transport blocks; and
combine each of the sums of the plurality of sums.

20. The apparatus of claim 16, wherein the instructions to multiplex the uplink control information on the one or more transport blocks are further executable by the processor to cause the apparatus to multiplex the uplink control information on the plurality of transport blocks, and the instructions are further executable by the processor to cause the apparatus to:
calculate a combination of a quantity of layers of each transport block of the plurality of transport blocks; and
calculate a product of the combination and a maximum effective modulation and coding scheme value, wherein the instructions executable by the processor to cause the apparatus to calculate the first quantity of resources are further based at least in part on the product.

21. The apparatus of claim 20, wherein the instructions are further executable by the processor to cause the apparatus to:
calculate the maximum effective modulation and coding scheme value between each transport block of the plurality of transport blocks, wherein an effective modulation and coding scheme value for a transport block is calculated by:
calculating a combination of a size of each code block of a plurality of code blocks associated with the transport block; and
calculating a separation of the combination by a quantity of layers of the transport block.

22. The apparatus of claim 16, wherein the instructions to multiplex the uplink control information on the one or more transport blocks are further executable by the processor to cause the apparatus to multiplex the uplink control information on the plurality of transport blocks, and the instructions are further executable by the processor to cause the apparatus to:
calculate a combination of a quantity of layers of each transport block of the plurality of transport blocks; and
calculate a product of the combination and a minimum effective modulation and coding scheme value, wherein the instructions executable by the processor to cause the apparatus to calculate the first quantity of resources are further based at least in part on the product.

23. The apparatus of claim 22, wherein the instructions are further executable by the processor to cause the apparatus to:
calculate the minimum effective modulation and coding scheme value between each transport block of the plurality of transport blocks, wherein an effective modulation and coding scheme value for a transport block is calculated by:
calculating a combination of a size of each code block of a plurality of code blocks associated with the transport block; and
calculating a separation of the combination by a quantity of layers of the transport block.

24. The apparatus of claim 16, wherein the instructions are further executable by the processor to cause the apparatus to:
output a second control message indicating a beta offset associated with the uplink control information, the control message comprising downlink control information, a medium access control-control element, radio resource control, or any combination thereof, wherein the instructions executable by the processor to cause the apparatus to calculate the first quantity of resources are further based at least in part on the beta offset.

25. The apparatus of claim 16, wherein the instructions to multiplex the uplink control information on the one or more transport blocks are further executable by the processor to cause the apparatus to multiplex one or more second uplink control information and first uplink control information on a same transport block, wherein the uplink control information comprises the first uplink control information, and the instructions are further executable by the processor to cause the apparatus to:
calculate a difference of a third quantity of resources available for uplink control information and a fourth quantity of resources associated with the one or more second uplink control information, wherein the instructions executable by the processor to cause the apparatus to calculate the second quantity of resources are further based at least in part on the difference.

26. The apparatus of claim 16, wherein the instructions to multiplex the uplink control information on the one or more transport blocks are further executable by the processor to cause the apparatus to multiplex one or more second uplink control information on one or more second transport blocks of the plurality of transport blocks, wherein the uplink control information comprises first uplink control information, and the instructions are further executable by the processor to cause the apparatus to:
calculate a difference of a third quantity of resources available for uplink control information and a fourth quantity of resources associated with the one or more second uplink control information, wherein the instructions executable by the processor to cause the apparatus to calculate the second quantity of resources are further based at least in part on the difference.

27. The apparatus of claim 16, wherein the first quantity of resources are a quantity of resources required to transmit the uplink control information and the second quantity of resources are a quantity of resources available to transmit the uplink control information.

28. The apparatus of claim 16, wherein the control message comprises downlink control information, radio resource control, or any combination thereof.

29. A method for wireless communication, comprising:
receiving a control message comprising scheduling for an uplink shared channel associated with a plurality of transport blocks;
multiplexing uplink control information with the uplink shared channel on one or more transport blocks of the plurality of transport blocks based at least in part on the control message;
calculating a first quantity of resources for the uplink control information and a second quantity of resources for the uplink control information based at least in part on the plurality of transport blocks;
calculating a minimum value between the first quantity of resources and the second quantity of resources; and
transmitting the uplink control information over the uplink shared channel using a set of resources that corresponds to the minimum value.

30. A method for wireless communication, comprising:
outputting a control message comprising scheduling for an uplink shared channel associated with a plurality of transport blocks;
multiplexing uplink control information with the uplink shared channel on one or more transport blocks of the plurality of transport blocks based at least in part on the control message;
calculating a first quantity of resources for the uplink control information and a second quantity of resources for the uplink control information based at least in part on the plurality of transport blocks;
calculating a minimum value between the first quantity of resources and the second quantity of resources; and
obtaining the uplink control information over the uplink shared channel using a set of resources that corresponds to the minimum value.
